(19) United States
(12) Patent Application Publication
(10) Pub. No.: US 2024/0380313 A1
(43) Pub. Date: Nov. 14, 2024

(54) PFC NETWORK CIRCUIT

(71) Applicant: ACD Antriebstechnik GmbH, Achstetten (DE)

(72) Inventor: Aaron Fesseler, Achstetten (DE)

(21) Appl. No.: 18/650,601

(22) Filed: Apr. 30, 2024

(30) Foreign Application Priority Data
May 8, 2023 (LU) 504159

(51) Int. Cl. H02M 1/42; H02M 1/12; H02M 1/44

(52) U.S. Cl. CPC H02M 1/4216; H02M 1/12; H02M 1/44

(57) ABSTRACT

A PFC network circuit with a half-bridge and a method for converting an AC power supply voltage to both a lower and a higher DC output voltage in compliance with PFC standards, the PFC network circuit comprising three phases, a rectifier comprising three inputs, a first and a second transistor controlled by a control unit, a midpoint arranged between the first and second transistors, a star point comprising three star capacitors and a capacitor connected to the midpoint and a reference potential, which can be either the zero potential of the network circuit or the star point of the star capacitors. The network circuit further comprises an output capacitor, an output coil, a diode and a string capacitor, wherein the output capacitor, the output coil, the diode and the string capacitor are provided at an output region of the network circuit.

### CROSS REFERENCE TO RELATED APPLICATIONS

This application claims priority to Luxembourg patent application LU504159, filed May 8, 2023. The above-referenced Luxembourg patent application LU504159 is hereby incorporated by reference herein in its entirety.

### BACKGROUND OF THE INVENTION

### Field of the Invention

The present invention relates to a network circuit for supplying electrical loads with direct current from a three-phase supply network and a method for modulating the string voltages from a three-phase supply network, in which the rectified voltage can be both stepped up and stepped down. The network circuit ensures that phase currents at the input of a rectifier are largely sinusoidal, regardless of the load. A network circuit is thus provided that enables an AC power supply voltage to be set high and low in compliance with PFC standards through targeted controlling of control elements.

### Brief Description of the Related Art

Network circuits are known from the prior art. Network circuits have the task of rectifying an AC power supply voltage applied to the input and increasing it to a value greater than the amplitude of the linked AC power supply voltage (step-up converter or boost converter) or decreasing it to a value less than the amplitude of the linked AC power supply voltage (step-down converter or buck converter).

It is known that there is a fixed physical relationship between the AC power supply voltage and the intermediate circuit voltage, as shown in FIG. 1. Electronic converter systems in the form of step-up converters and step-down converters enable the AC power supply voltage to be converted to a higher or lower intermediate circuit voltage UZK or DC output voltage. The known electronic converter systems attempt to achieve sinusoidal phase currents. These are then referred to as PFC step-up converters or PFC step-down converters with PFC for power factor correction (PFC).

It is known that many loads connected to the public supply network extract pulsed network currents through simple bridge rectifiers, which are associated with large harmonic currents and therefore large reactive power consumption. These pulsed currents require the public supply network to be oversized. In addition, there are short-term voltage dips and voltage peaks, which increasingly lead to problems with sensitive loads. For this reason, there are corresponding (PFC) standards (see, for example, DIN EN IEC 61000 March 2 (VDE 0838-2), December 2019 and DIN EN 61000 March 12 (VDE 0838-12), June 2012), which require the use of so-called power factor correction (PFC) above a certain power level. The use of active circuit solutions becomes necessary as a result, since the components in passive systems require a larger installation space and deliver currents with a shape that deviates from a sine wave.

EP 3 068 024 A1, for example, discloses a three-phase pulse rectifier system with comparatively low reverse voltage stress on the power semiconductors that can be switched off and high-power density, as well as low system feedback. Such a three-phase, three-point pulse rectifier, also referred to as a so-called Vienna rectifier, is known to be characterized by a significantly lower harmonic content on the AC voltage side in contrast to conventional six-pulse bridge circuits used for rectifying three-phase current.

US 2013/0 194 838 A1 discloses a three-phase step-up rectifier with low input current and harmonics, comprising an input stage for receiving a three-phase input voltage with respect to a neutral point and an output stage suitable for coupling to at least one load.

U.S. Pat. No. 5,933,336 A discloses a step-up converter comprising a first, second and third phase input and an output. The step-up converter further comprises first and second switches or transistors connected between corresponding lines of the output. The step-up converter also comprises first, second and third capacitors forming first, second and third L-C series paths with a first inductor, respectively. The first, second and third L-C series paths are coupled between the first, second and third phase inputs, respectively, and a node between the first and second switches. The first and second switches progressively cooperate to use a voltage across the lines minus a voltage across the first, second and third capacitors to discharge currents through the first inductor and thereby reducing the total harmonic distortion (THD) of the input current at all three phase inputs.

EP 0 973 245 A2 discloses a circuit in which inductors are coupled to three phase inputs. Two switches are coupled between the terminals of the output. Three capacitors are connected in a star configuration to the three phase inputs, with the star point connected to the node between the switches. A rectifier with diodes is inserted between the inductors and the switches. The output is coupled to the switches via an output capacitor. The phase inputs are fed via an electromagnetic interference suppression filter. The inductors operate in gap mode (Discontinuous Current Modem DCM). A control loop controls the switches. The switches work together progressively by using the voltage across the outputs, which is lower than that across the capacitors, to discharge the current through the inductors and reduce the total input current distortion at all phase inputs.

From WO 93/12 576 A1 a circuit is known to generate a current that is a harmonic of the frequency of a supply system and that has a selected amplitude and phase to reduce the total harmonic distortion of a system that converts alternating current to direct current or vice versa. The DC signal is sampled and, by controlling switches, a sinusoidal current with the desired harmonic is generated and provided to an impedance network that feeds this current into the multi-phase AC system of the electric power supplier. The impedance network comprises a single inductor and capacitor connected in series through each of the phases of the power supplier, with the current signal having an amplitude selected to substantially eliminate harmonics that cause high distortion of the supply signal.

CN 102 130 572 A discloses a three-phase rectifier bridge DC side parallel circuit type active power filter. The active power filter comprises a coupling element on the AC side of a three-phase rectifier bridge which is a low-frequency bidirectional power switch, and wherein the coupling element is an impedance. The active power filter improves upon the prior art, in which two capacitors and four high-frequency power switching tubes used in two boost-type bidirectional power converters are mutually connected in series, in that only one capacitor and three high-frequency power switching tubes are required. Thus, compared to the prior art, the active power filter does not need to equalize the voltage between the two original capacitors and therefore exhibits better harmonic suppression.

Network circuits that can convert an AC power supply voltage into a resulting rectified intermediate circuit voltage are therefore known from the prior art. However, in order to be able to both step-up and step-down the AC power supply voltage, the known network circuits are usually set up as PFC step-up converters and equipped with a separate downstream step-down converter circuit. Converter systems with transformers are also used for this purpose.

Such network circuits require a large number of components to step-up or increase the AC power supply voltage, as is the case with the Vienna rectifier, for example, which makes them very expensive and also requires very complex controlling. In order to obtain a lower intermediate circuit voltage from the previously increased voltage, a step-down converter circuit must be connected downstream in addition to this circuit, which again requires additional components. In addition to the increasing costs, the efficiency also deteriorates significantly when two converter systems are connected in series (by multiplying the efficiencies of the individual converter systems). The deterioration in efficiency can be generalized for all PFC step-up converter topologies in which a step-down converter circuit must be connected downstream.

An example of a PFC step-up converter topology without a downstream converter circuit is known from WO 2021/260222 A1, for example. As shown in FIG. 2, this discloses a network circuit N for providing an intermediate circuit direct voltage UZK and a load-dependent intermediate circuit current IZK at an output OUT from a three-phase supply network VN. The network circuit N comprises a capacitor CS in a midpoint network that serves as an adjustable voltage source for setting a voltage difference via storage chokes LL1, LL2, LL3 as energy storage on a rectifier GR. By selectively controlling control elements ST, the AC power supply voltage can be increased while complying with PFC standards. However, the disadvantage of this network circuit is that only one step-up is possible.

If we consider a PFC step-down converter (buck converter), there are also various well-known step-down converter topologies with downstream step-up converter circuits. The large number of components also leads to a noticeable deterioration in the efficiency of this type of circuit. In addition, complex control is also required.

Other examples of downstream converters in PFC circuits are known as CUK or SEPIC converters. However, network circuits that combine CUK or SEPIC converters are very complex and require additional components, as CUK or SEPIC converters only function at a constant input voltage due to control laws. The large number of components also leads to a noticeable decrease in the efficiency of this type of circuit.

It is therefore the object of the present application to provide a network circuit without a downstream step-up or step-down circuit and a method which directly converts an AC power supply voltage and the resulting rectified voltage into both a lower and a higher intermediate circuit direct voltage while complying with the PFC standards, thereby overcoming the aforementioned disadvantages of the known network circuits.

### SUMMARY OF THE INVENTION

This object is solved by a PFC network circuit with a half-bridge and a method for converting an AC power supply voltage into both a lower and a higher DC output voltage while complying with PFC standards.

The PFC network circuit comprises three phases, a rectifier comprising three inputs, a first and a second transistor or switch which are controlled by a control unit, a midpoint which is arranged between the first and the second transistor, a star point comprising three star capacitors and a capacitor connected to the midpoint and a reference potential which can be either the zero potential of the network circuit or the star point of the star capacitors. The network circuit further comprises an output capacitor, an output coil, a diode and a string capacitor, wherein the output capacitor, the output coil, the diode and the string capacitor are provided at an output region of the network circuit. The network circuit also comprises three storage chokes, each of which being connected to one of the three phases and one of the three inputs of the rectifier. The capacitor is configured to serve as an adjustable voltage source by selectively charging and discharging by controlling the first and second transistors and to adjust a voltage difference across the three storage chokes in order to meet PFC standards. The control unit is arranged to control the first transistor and the second transistor so that an AC power supply voltage is converted into a stepped-up or stepped-down DC output voltage depending on a polarity of string voltages. Controlling the first and second transistors is conducted by the control unit by positive and negative controlling.

In this way, a network circuit is provided which makes it possible to convert an AC power supply voltage into a lower as well as a higher DC output voltage while complying with PFC standards by controlling only the first and second transistors. Thus, with the same control elements, a sinusoidal current is derived from the supply network in accordance with the control in order to fulfil the PFC standards. The network circuit increases effectiveness and energy efficiency due to unnecessary downstream topologies, reduces the number of components and thus lowers costs.

According to one aspect, the diode comprises at least one of a positive diode in the positive path, a negative diode in the negative path, or the positive diode in the positive path and the negative diode.

The diode allows the output of the network circuit to be completely electrically decoupled from the rest of the network circuit. Furthermore, the network circuit becomes earth-symmetrical and offers further advantages in terms of EMC (electromagnetic compatibility) and leakage currents. This reduces the electrical load on the individual components of the network circuit.

According to a further aspect, the string capacitor comprises at least one of a positive-strand capacitor in the positive string, a negative-strand capacitor in the negative string or the positive-strand capacitor in the positive string and the negative-strand capacitor in the negative string.

If the string capacitor only comprises the positive string capacitor or the negative string capacitor, the volume of the installation space can be reduced. If the string capacitor comprises the positive string capacitor and the negative string capacitor, the output of the network circuit can be completely decoupled capacitively from the rest of the network circuit. Furthermore, the network circuit becomes earth-balanced and offers further advantages in terms of EMC (electromagnetic compatibility) and leakage currents. This reduces the electrical load on the individual components of the network circuit. In the event of a failure of components in the network circuit, there is no breakdown of the input voltage at the output.

According to a further aspect, the output coil comprises at least one of a positive output coil in the positive path, a negative output coil in the negative path or the positive output coil in the positive path and the negative output coil.

If the output coil includes the positive output coil and the negative output coil, the output of the network circuit can be completely decoupled inductively from the rest of the network circuit. Furthermore, the network circuit becomes earth-symmetrical and offers further advantages in terms of EMC (electromagnetic compatibility) and leakage currents. This reduces the electrical load on the individual components of the network circuit.

According to a further aspect, the network circuit further comprises a positive decoupling diode provided at the output region of the network circuit in the positive path and a negative decoupling diode provided at the output region of the network circuit in the negative path.

The positive decoupling diode and the negative decoupling diode improve the inductive decoupling of the output of the network circuit and a unidirectional current flow can be permitted. Furthermore, the network circuit becomes earth-symmetrical and offers further advantages in terms of EMC (electromagnetic compatibility) and leakage currents. This reduces the electrical load on the individual components of the network circuit. According to a further aspect, the network circuit is multi-channel.

Thanks to the multi-channel design, the network circuit can be used in larger power ranges.

According to a further aspect, the channels of the multi-channel network circuit are operated synchronously or offset according to the interleave principle.

The interleave principle can be used to divide the energy supply to the components of the network circuit in order to reduce the load on the components. Furthermore, the ripple of the output voltage can be reduced, allowing a lower capacitance of the output capacitor to be selected (smoothing capacitance).

This object is further solved by a method for converting an AC power supply voltage into a lower or higher DC output voltage while complying with PFC standards on a network circuit. The method comprises controlling the first and second transistors, charging and discharging the capacitor depending on the controlling, generating a capacitor voltage in the capacitor, influencing a voltage difference at three storage chokes by the capacitor voltage of the capacitor, and extracting sinusoidal phase currents from a supply network, wherein limit values for harmonic currents of the PFC standard are complied with. The controlling comprises positive and negative controlling and takes into account the polarity of string voltages. The coil voltages of the storage chokes correspond to a voltage difference between the capacitor voltage and the AC power supply voltage as a result of charging and discharging. The DC output voltage is set higher or lower than the AC power supply voltage depending on the controlling.

By controlling only the first and second transistors of the network circuit, the DC output voltage can be set up or down while complying with the PFC standards. This leads to an increase in effectiveness and energy efficiency as well as a reduction in the number of components and thus costs.

According to one aspect, the first transistor and second transistor are controlled in such a way that the DC output voltage is regulated to a desired value depending on the load, with at least one of a switch-on duration, a short-circuit duration and a switch-off duration of the first and second transistors serving as degrees of freedom.

According to a further aspect, the controlling is carried out in such a way that limit values for harmonic currents of the PFC standards are complied with.

### BRIEF DESCRIPTION OF THE DRAWINGS

The invention will now be explained in more detail with reference to drawings. They show:

FIG. 1 shows a known fixed physical relationship between an AC power supply voltage and an intermediate circuit voltage.

FIG. 2 shows a known PFC step-up converter topology without a downstream converter circuit.

FIG. 3 shows a network circuit according to a first embodiment example.

FIG. 4 shows a rectifier of the network circuit of FIG. 3.

FIG. 5 shows the network circuit according to a second embodiment example.

FIG. 6 shows a first modification of an output region of the network circuit.

FIGS. 7A and 7B show a second modification of an output region of the network circuit.

FIG. 8 shows a third modification of an output region of the network circuit.

FIG. 9 shows a fourth modification of an output region of the network circuit.

FIGS. 10 and 11 show a multi-channel structure of the network circuit.

FIG. 12 shows a course of control signals with positive controlling.

FIG. 13 shows a course of control signals with negative controlling.

FIG. 14 shows different characteristic curves with positive controlling in step-up operation of the network circuit of FIG. 3.

FIG. 15 shows different characteristic curves with negative controlling in step-up operation of the network circuit of FIG. 3.

FIG. 16 shows different characteristic curves with positive controlling in step-down operation of the network circuit of FIG. 3.

FIG. 17 shows different characteristic curves with negative controlling in step-down operation of the network circuit of FIG. 3.

FIG. 18 shows different characteristic curves with positive controlling in step-up operation of the network circuit of FIG. 5.

FIG. 19 shows different characteristic curves with negative controlling in step-up operation of the network circuit of FIG. 5.

FIG. 20 shows different characteristic curves with positive controlling in step-down operation of the network circuit of FIG. 5.

FIG. 21 shows different characteristic curves with negative controlling in step-down operation of the network circuit of FIG. 5.

FIGS. 22A and 22B show method steps for positive and negative controlling of the network circuit.

FIGS. 23, 24A, 24B and 24C show a course of network variables in step-up and step-down operation of the network circuit in FIG. 3.

FIGS. 25A-25C and 26A-26C show a course of network variables in step-up and step-down operation of the network circuit in FIG. 5.

FIG. 27A-27C show method steps for positive and negative controlling of the network circuit.

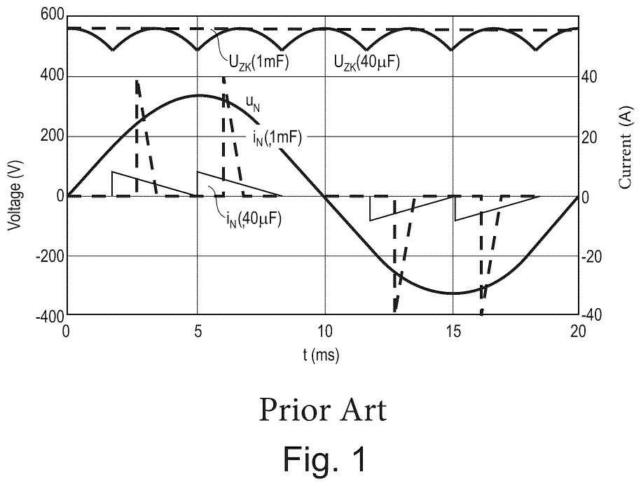

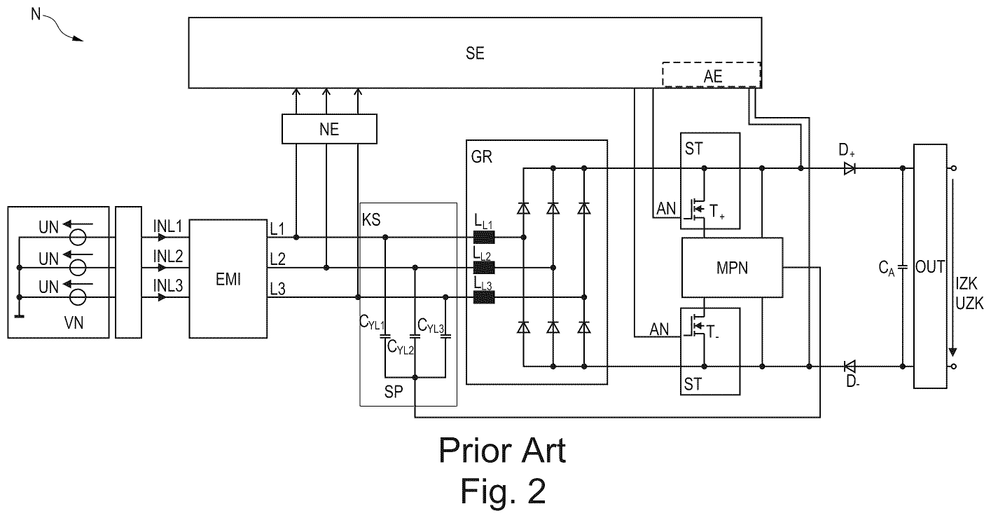

### DETAILED DESCRIPTION OF THE INVENTION

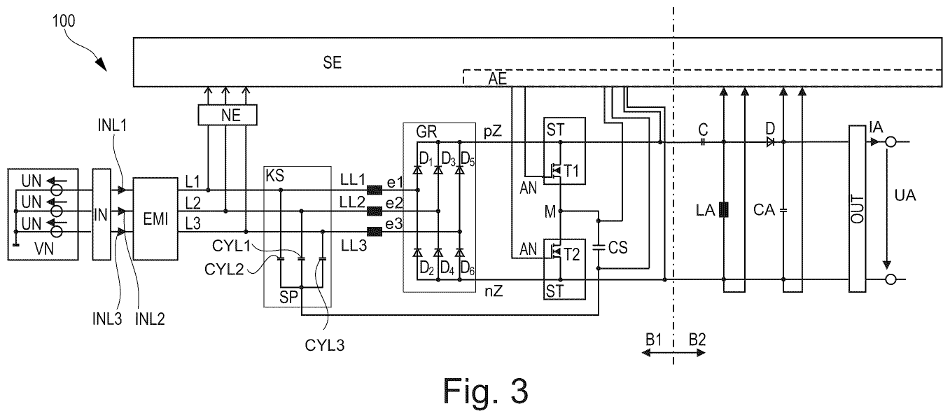

FIG. 3 illustrates a general structure of a single-channel network circuit 100 according to a first embodiment example for providing a stepped-up or stepped-down DC output voltage UA at an output of the network circuit 100 from an AC power supply voltage uN (u1, u2, u3) from a three-phase supply network VN.

The network circuit 100 comprises a plurality of components which are connected to each other. In an input region B1, the network circuit 100 comprises an input IN, an EMI filter or filter for electromagnetic interference, a network detection NE, a control unit SE optionally comprising an output detection AE, a coupling circuit KS, a rectifier GR, at least one control element ST or a first transistor T1 and a second transistor T2, a midpoint M, arranged between the first transistor T1 and the second transistor T2, a capacitor CS, and, in an output region B2 an output capacitor CA, an output coil LA, a diode D, a string capacitor C, and an output OUT.

The first transistor T1 and the second transistor T2 are transistors, each comprising control inputs AN and a body diode (not shown) or a freewheeling diode (not shown) connected in parallel with the transistors T1, T2. The control inputs AN are connected to the control unit SE, so that the first transistor T1 and the second transistor T2 are each controlled via the control inputs AN via the control unit SE. The capacitor CS is connected to the midpoint M and a zero potential NP of the network circuit 100. The first transistor T1, the midpoint M and the second transistor T2 form a half-bridge or an electronic half-bridge circuit.

At input IN, the network circuit 100 is connected to the supply network VN via phases L1, L2, L3. The phases L1, L2, L3 comprise network variables NG. The network variables NG comprise at least one of a phase position PL, string voltage UN (string voltages u1, u2, u3) and phase currents iNL1, iNL2, iNL3.

The input IN is followed by the EMI filter EMI, which is used to filter electromagnetic interference in a known manner. For this reason and for the sake of brevity, the EMI filter is not described in more detail here.

The respective network variables NG of phases L1, L2, L3 are detected by the network detection NE in various circuit paths and passed on to the control unit SE. The network detection NE is arranged between the EMI filter and the coupling circuit KS. Here, the circuit paths comprise a positive path pZ and a negative path nZ.

If the supply network VN is a four-wire three-phase system with neutral conductor, a symmetrical neutral point is created at the supply network VN (not shown).

The control unit SE can optionally be expanded with the output detection AE in order to detect voltage variables and current variables at different positions, in particular at the output OUT of the network circuit 100. The output detection thus detects at least one of a DC output voltage UA and an output current IA at the output OUT.

The coupling circuit KS is followed by the rectifier GR, which in the example shown comprises three inputs e1, e2, e3 and is constructed with rectifier diodes D1, D2, D3, D4, D5, D6 as energy storage. The inputs e1, e2 and e3 connect the rectifier GR to the phases L1, L2, L3. Storage chokes LL1, LL2, LL3 are provided between the coupling circuit KS and the rectifier GR. However, the rectifier GR is not limited to this embodiment example. The rectifier GR can also be configured with controllable components, non-controllable components and/or a combination thereof. The rectifier GR can thus be a rectifier and inverter that enables a feedback option into the supply network VN.

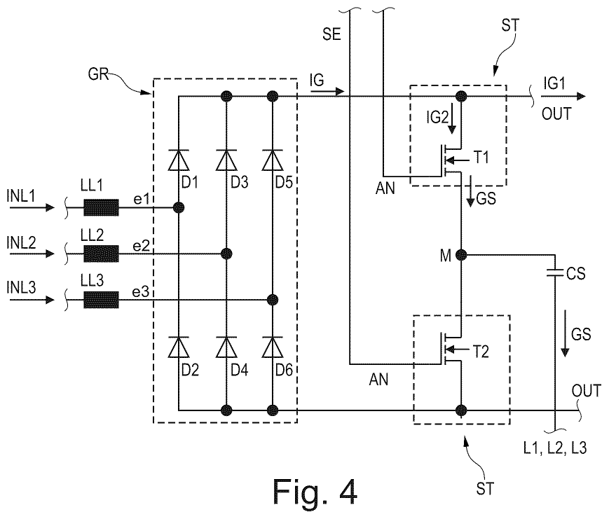

As shown in FIG. 4, the rectifier GR rectifies the phase currents iNL1, iNL2, iNL3 in the phases L1, L2, L3, whereby a rectified current IG is generated. The rectified current IG is divided into a first rectified current IG1 and a second rectified current IG2, depending on the clock state of the first transistor T1. The second rectified current IG2 is passed through the first transistor T1. The first rectified current IG1 supplies the output OUT of the network circuit 100 via the positive path pZ.

In the network circuit 100, the control inputs AN of the first transistor T1 and the second transistor T2 are controlled by the control unit SE. The second rectified current IG2 is converted into a clocked signal GS by controlling the control inputs AN by the control unit SE. The clocked signal GS corresponds to a capacitor current iCS via the capacitor CS.

The clocked signal GS is forwarded from the first transistor T1 via the midpoint M and the capacitor CS to the phases L1, L2, L3, as can be seen in FIG. 3. The capacitor CS is specifically charged by the clocked signal GS. The voltage to which the capacitor CS is charged corresponds to the integrated capacitor current iCS divided by a capacitance value of the capacitor CS.

The difference between the respective string voltages and the voltage value at the capacitance determines the currents through the storage chokes LL1, LL2, LL3 and thus ensures sinusoidally modulated phase currents iNL1, iNL2, iNL3.

The capacitor CS thus serves as a voltage source and provides an adjustable voltage difference via the storage choke(s) LL1, LL2, LL3 by controlling the first transistor T1 or second transistor T2. In this way, the network circuit 100 guarantees a sinusoidal current extraction from the supply network VN to meet the PFC standards.

The coupling circuit KS is provided between the EMI filter or the network detection NE and the rectifier GR and is connected to the midpoint M. The coupling circuit KS filters out the high-frequency current contents generated by the clocking of the transistors from the phase currents. In other words, the coupling circuit KS ensures that higher-frequency currents caused by the clocking of the first transistor T1 and/or the second transistor T2 are not visible in the phase currents iNL1, iNL2, iNL3.

The coupling circuit KS is a capacitor star circuit comprising three star capacitors CYL1, CYL2, CYL3 forming a star point SP. The midpoint M is connected to the star point SP of the capacitor star circuit via the capacitor CS. The phase currents iNL1, iNL2, iNL3 are modulated at the phases L1, L2, L3 with the forwarded clocked signal GS via the capacitor star circuit KS. The forwarded clocked signal GS is therefore fed back to the star point SP of the coupling circuit KS.

In order to capacitively isolate the output OUT from the input IN, a string capacitor C is provided in the positive path pZ after the first transistor T1 in the first embodiment example of the network circuit 100. After the string capacitor C in the direction of the output OUT, the output coil LA is provided between the positive path pZ and the negative path nZ. The output coil LA fulfills the function of an output-side storage choke (energy storage), which is required for the function of the circuit (step-up and step-down). In order to decouple the output region B2 from the network circuit 100 so that the DC output voltage UA remains at an earth-symmetrical potential regardless of the clock, a diode is provided in the positive path pZ downstream of the string capacitor C and the output coil LA in the first embodiment example of the network circuit 100. Finally, the output capacitor CA is provided at the output OUT between the positive path pZ and the negative path nZ. Due to this specific arrangement of the aforementioned components in the output region B2, the network circuit 100 according to the first embodiment example corresponds to a non-inverting three-phase buck-boost converter topology.

FIG. 5 shows a general structure of the single-channel network circuit 100 according to a second embodiment example for providing a stepped-up or stepped-down DC output voltage UA at the output OUT of the network circuit 100 from an AC power supply voltage uN from a three-phase supply network VN.

The network circuit 100 according to the second embodiment example differs from the first embodiment example in that the output coil LA and the diode D are arranged differently in the output region B2. The components in the input region B1 are the same as in the first embodiment example and are arranged in the same way. Therefore, for the sake of brevity, these components are not described again in detail.

In the network circuit 100 according to the second embodiment example, the diode D is provided between the positive path pZ and the negative path nZ in the output region B2 downstream of the string capacitor C in the positive path pZ in the direction of the output OUT. Furthermore, the output coil LA is provided in the positive path pZ after the string capacitor C and the diode.

Due to the different arrangement of the output coil LA and the diode D in the output region B2 of the network circuit 100 according to the second embodiment example, the DC output voltage UA and the output current IA are correspondingly inverted compared to the first embodiment example of the network circuit 100. The network circuit 100 according to the second embodiment example therefore corresponds to an inverting three-phase buck-boost converter topology.

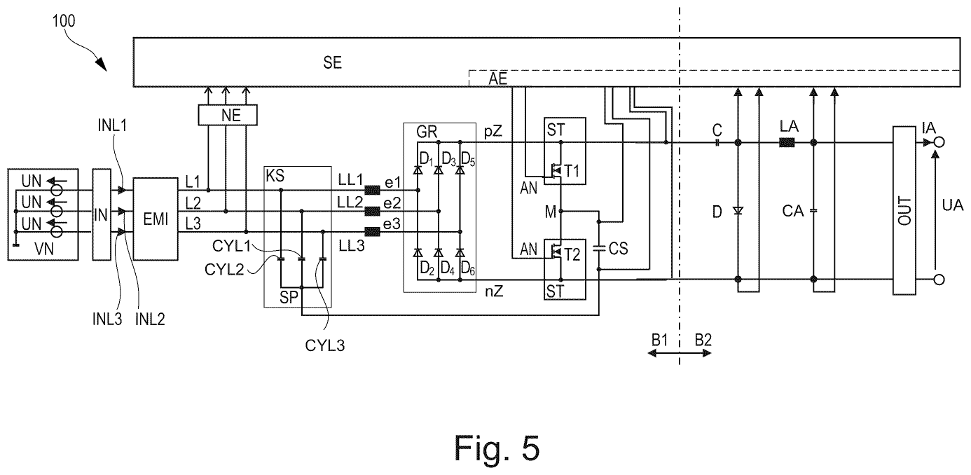

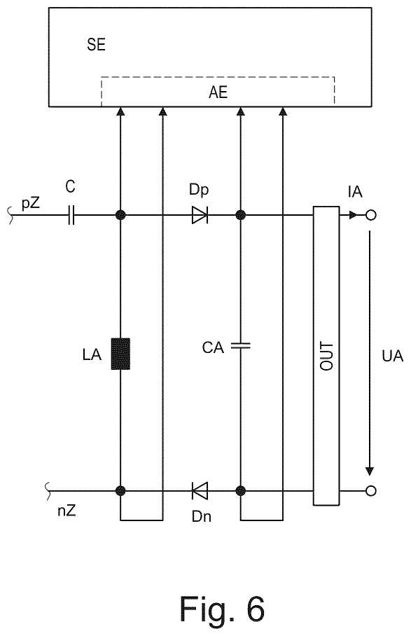

FIG. 6 shows the output region B2 of the network circuit 100 according to the first output example corresponding to a first modification. According to the first modification, the diode D comprises at least one of a positive diode Dp in the positive path pZ and a negative diode Dn in the negative path nZ. The diode D can comprise only the positive diode Dp in the positive path pZ or the negative diode Dn in the negative path nZ or both of the positive diode Dp and the negative diode Dn.

By using two diodes, i.e. the positive diode Dp in the positive path pZ and the negative diode Dn in the negative path nZ, the output region B2 of the network circuit 100 can be decoupled so that the DC output voltage UA remains at an earth-symmetrical potential regardless of the clock. An active diode in the form of a transistor can also be used to improve efficiency. The network circuit 100 according to the first modification can thus be realized only with the positive diode Dp in the positive path pZ, only with the negative diode Dn in the negative path nZ or with both diodes, the positive diode Dp and the negative diode Dn.

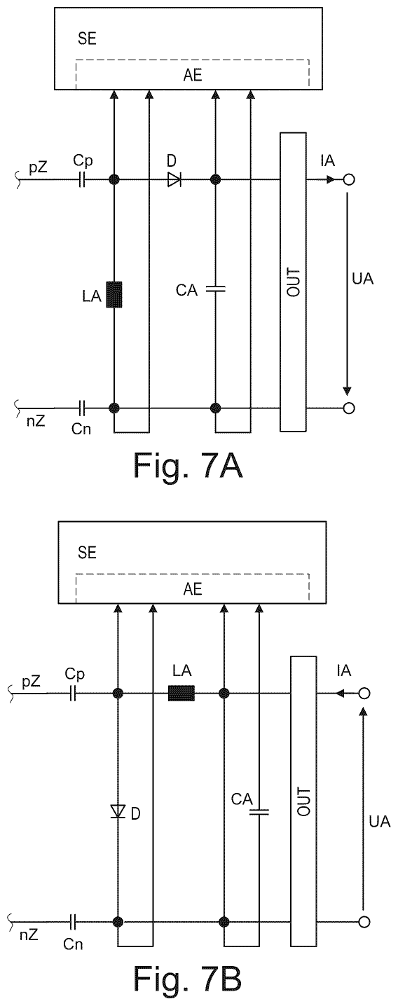

FIGS. 7A and 7B show the output region B2 of the network circuit 100 according to the first output example (FIG. 7A) and the output region B2 of the network circuit 100 according to the second embodiment example (FIG. 7B) corresponding to a second modification. According to the second modification, the string capacitor C comprises at least one of a positive string capacitor Cp in the positive path pZ and a negative string capacitor Cn in the negative path nZ. The string capacitor C can comprise only the positive-strand capacitor Cp in the positive path pZ or the negative-strand capacitor Cn in the negative path nZ or both of the positive-strand capacitor Cp and the negative-strand capacitor Cn.

The advantage of splitting the string capacitor C is that the output OUT is capacitively decoupled or separated from the input IN of the network circuit 100. High voltages occur at string capacitor C during operation. By splitting the string capacitor C into the positive string capacitor Cp and the negative string capacitor Cn, capacitors with a lower dielectric strength can be used, as the voltage is halved in this case. It should be noted that the positive-terminal capacitor Cp and the negative-terminal capacitor Cn correspond to a series connection. In order to obtain the same total capacitance with the positive string capacitor Cp and the negative string capacitor Cn as with the single string capacitor C, the positive string capacitor Cp and the negative string capacitor Cn must be twice as large as the string capacitor C.

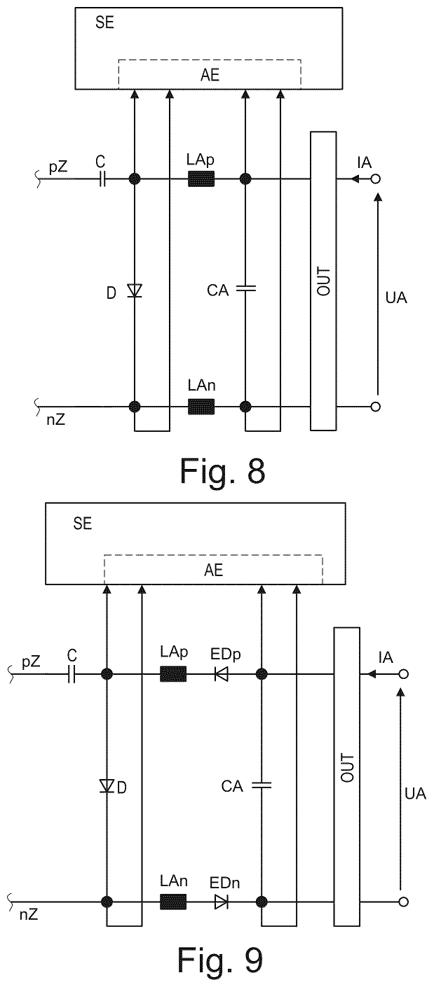

FIG. 8 shows the output region B2 of the network circuit 100 according to the second output example corresponding to a third modification. According to the third modification, the output coil LA comprises at least one of a positive output coil LAp in the positive path pZ and a negative output coil LAn in the negative path nZ. The output coil LA can comprise only the positive output coil LAp in the positive path pZ or the negative output coil LAn in the negative path nZ or both of the positive output coil LAp and the negative output coil LAn.

FIG. 9 shows the output region B2 of the network circuit 100 according to the second output example corresponding to a fourth modification. The fourth modification can be regarded as a further modification of the third modification according to FIG. 8. According to the fourth modification, the output region B2 of the network circuit 100 according to FIG. 8 is extended by a positive decoupling diode EDp and a negative decoupling diode EDn. The positive decoupling diode EDp is provided downstream of the positive output coil LAp to the output OUT in the positive path pZ. The negative decoupling diode EDn is provided downstream of the negative output coil LAn to the output OUT in the negative path nZ.

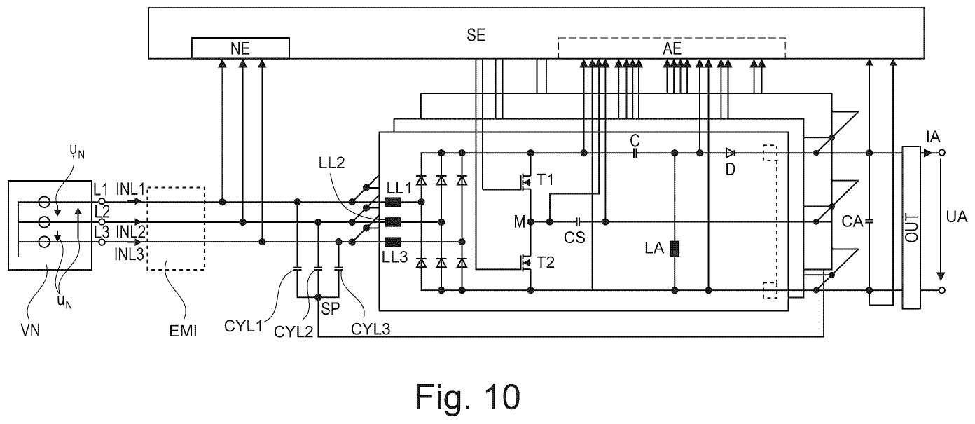

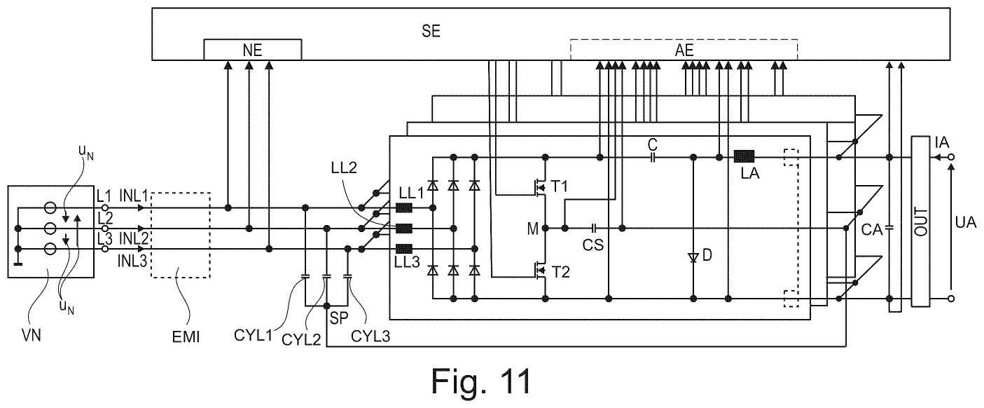

FIGS. 10 and 11 show a multi-channel structure of the network circuit 100 according to the first embodiment example (FIG. 10) and a multi-channel structure of the network circuit 100 according to the second embodiment example (FIG. 11) for providing a stepped-up or stepped-down DC output voltage UA for use in larger power ranges.

As shown, the structure of the network circuit 100 between the coupling circuit KS and the output capacitor CA is connected in multiple channels or multiple parallel connections.

The multi-channel structure of the network circuits 100 shown in FIG. 10 and FIG. 11 can be operated either synchronously or according to the familiar interleave principle. With the interleave principle, the individual structures clock offset to each other. For example, with two structures or a two-channel design, clocking is typically offset by half the period duration. With n structures, for example, the clocking is offset by n shifts within a period duration. The clocking or controlling takes place via the control unit SE.

The star point SP realized with the three star capacitors CYL1, CYL2, CYL3 serves as a common reference point for all capacitors CS of the plurality of structures. A neutral conductor present in a four-wire three-phase system can also be used as a reference point. Alternatively, each structure could provide an independent midpoint M or star point SP for the capacitor CS via capacitors, i.e. three separate star capacitors would be provided for each structure upstream of the storage chokes LL1, LL2, LL3.

The capacitor CS of the midpoint M is specifically charged by a special type of controlling of the control input AN of the at least one of the first transistor T1 and the second transistor T2 by the control unit SE. The charging of the capacitor CS corresponds to at least one of precharging, charging, recharging and discharging. The type of charging of the capacitor CS depends on the network variables detected by the network detection NE and the output detection AE.

The capacitor voltage uCS on the capacitor CS modulates the coil voltages uLL1, uLL2, uLL3 in such a way that sinusoidal phase currents iNL1, iNL2, iNL3 are extracted from the phases L1, L2, L3 of the supply network VN. In other words, the capacitor voltage uCS at the capacitor CS, which is specially adjusted to the network variables, is used for dynamic compensation of deviations in the coil voltages uLL1, uLL2, uLL3 at the storage chokes LL1, LL2, LL3 in such a way that sinusoidal phase currents iNL1, iNL2, iNL3 are extracted from the phases L1, L2, L3 of the supply network VN in order to comply with the PFC standards. The compensation is dynamic, as the level of the capacitor voltage uCS depends on the controlling of the first and second transistors T1, T2 by the control unit SE, wherein the control depends on the network variables detected by the network detection NE and the output detection AE.

The level of the capacitor voltage uCS therefore depends on a pulse duty factor or duty cycle TV, as described below. Through modulation, the phase currents iNL1, iNL2, iNL3 become essentially sinusoidal currents or have essentially sinusoidal courses, which correspond to the PFC standards in all power ranges. The modulation corresponds to a pulse width modulation, pulse frequency modulation or other known modulation methods. The sinusoidal currents are extracted from the supply network VN at the input of the network circuit 100.

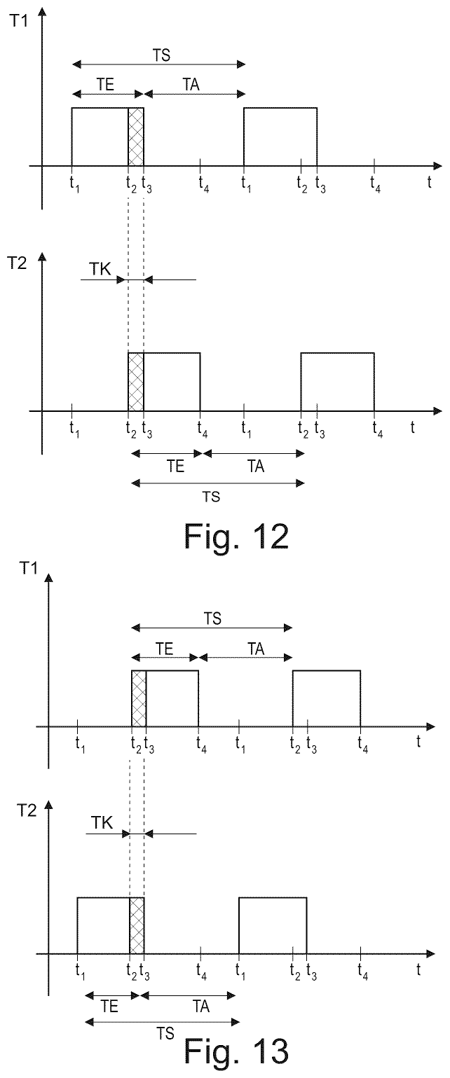

By charging the capacitor CS depending on the special type of controlling, the capacitor CS serves as an adjustable voltage source for generating a voltage difference across the storage chokes LL1, LL2, LL3. The voltage difference across the storage chokes LL1, LL2, LL3 can be influenced by the charge of the capacitor CS in such a way that in corresponding time periods, as shown in FIGS. 12 to 26C, greater coil voltages uLL1, uLL2, uLL3 are applied to the storage chokes LL1, LL2, LL3 than are physically provided by the supply network VN. As a result, essentially sinusoidal currents are extracted from the supply network VN in all phases L1, L2, L3, whereby the limit values of the PFC standards can be complied with in the corresponding power classes.

For this purpose, the first transistor T1 and the second transistor T2 each receive control signals ST1, ST2 from the control unit SE that are dependent on the detected network variables, whereby the first transistor T1 and the second transistor T2 are clocked. The clocking caused by the controlling of the transistors T1, T2 by the control unit SE determines different time intervals, such as a switch-on duration TE of the first transistor T1, a switch-on duration TE of the second transistor T2 and a short-circuit duration TK, which defines a short-circuit range in which both transistors T1, T2 are switched on or are conductive at the same time. The remaining time in which the first transistor T1 or the second transistor T2 are not switched on or are conducting is defined as the switch-off time TA. The sum of the switch-on duration TE and switch-off duration TA forms a period duration TS. The sequence of the time intervals distinguishes between a positive controlling and a negative controlling. This special timing is described in detail below with reference to FIGS. 12 and 13. The control unit SE regulates the modulation via the length of the time intervals. At the same time, the length of the time intervals and the short-circuit duration TK are used to control the level of the DC output voltage UA. The capacitor CS is charged during the time intervals. Charging takes place in relation to the star point SP.

In one example, one of the time intervals (switch-on duration TE, switch-off duration TA) can be shorter than the other of the time interval. This allows the network circuit 100 to be set up for a cleanly regulated DC output voltage UA or for a PFC-compliant sinusoidal current extraction. This allows a first clock period TS1 to be set up in which the network currents iNL1, iNL2, iNL3 sufficiently comply with the PFC limit values by reducing the harmonics or reduce the harmonics. The DC output voltage UA can be kept stable with a subsequent second clock period TS2. In a further non-restrictive example, a third clock period TS3 can also be added to achieve further improvements. Furthermore, all clock periods can be set up in such a way that the network circuit 100 is only set up for a cleanly regulated DC output voltage UA or for a PFC-compliant sinusoidal current extraction.

FIG. 12 shows a course of a first control signal ST1 for the first transistor T1 and a course of a second control signal ST2 for the second transistor T2 based on the positive controlling of the first transistor T1 and the second transistor T2 over time t.

With positive controlling, the control inputs AN of the first and second transistors T1, T2 are controlled by the control unit SE in such a way that the first transistor T1 is conductive between a first time t1 and a third time t3 for a switch-on duration TE and then the second transistor T2 is conductive between a second time t2 and a fourth time t4 for the switch-on duration TE. Between the second time t2 and the third time t3, for a short-circuit duration TK, the first and second transistors T1, T2 are simultaneously conductive. While the first control signal ST1 is zero, the first transistor T1 is non-conductive. The first transistor T1 is non-conductive for a switch-off duration TA between the third time t3 of a current period duration TS, consisting of the sum of the switch-on duration TE and the switch-off duration TA, up to the first time t1 of the next period duration, while the first transistor T1 is not controlled by the control unit SE. While the second control signal ST2 is zero, the second transistor T2 is non-conductive. The second transistor T2 is non-conductive for the switch-off duration TA between the fourth time t4 of the current period duration TS to the second time t2 of the next period duration, while the second transistor T2 is not controlled by the control unit SE.

A reciprocal of the period duration TS results in a clock frequency fS, or fS=1/TS, with which the first transistor T1 and the second transistor T2 are clocked through controlling by the control unit SE. It should be noted that the clocking must be carried out with a sufficiently high clock frequency fS compared to the network frequency fN in order to minimize the effort required to filter the harmonics caused by the clocking.

FIG. 13 shows a course of the first control signal ST1 for the first transistor T1 and a course of the second control signal ST2 for the second transistor T2 based on the negative controlling of the first transistor T1 and the second transistor T2 over the time t.

With negative controlling, the switch-on duration TE, switch-off duration TA, short-circuit duration TK and switching period TS correspond to those of positive controlling, with the difference that they start and end at different times. This means that the same applies to the switch-on duration TE, switch-off duration TA, short-circuit duration TK and switching period TS as for positive controlling.

With negative controlling, the control inputs AN of the first and second transistors T1, T2 are controlled by the control unit SE in such a way that the second transistor T2 is conductive between the first time t1 and the third time t3 for the switch-on duration TE and then the first transistor T1 is conductive between the second time t2 and the fourth time t4 for the switch-on duration TE. Between the second time t2 and the third time t3, for the short-circuit duration TK, the first and second transistors T1, T2 are simultaneously conductive. The first transistor T1 is non-conductive for a switch-off duration TA between the fourth time t4 of the current period duration TS up to a second time t2 of the next period duration, while the first transistor T1 is not controlled by the control unit SE. The second transistor T2 is non-conductive for the switch-off duration TA between the third time t3 of the current period duration TS up to the first time t1 of the next period duration, while the second transistor T2 is not controlled by the control unit SE.

With negative controlling, it is also important to ensure that the clock frequency fS is sufficiently high compared to the network frequency fN.

The DC output voltage UA can optionally be controlled via the duty cycle TV of switch-on duration TE to switch-off duration TA or period duration TS of the first and second transistors T1, T2 and in conjunction with the short-circuit duration TK.

With the network circuit 100 and the special positive and negative controlling, it is possible to generate a DC output voltage UA from an AC power supply voltage uN that is lower (step-down) or higher (step-up) than that from a standard three-phase rectification. This means that when stepping up, the DC output voltage UA is greater than the AC power supply voltage uN, and that when stepping down, the DC output voltage UA is less than the AC power supply voltage uN. The level of the DC output voltage UA depends on the clocking, wherein the change between step-up and step-down is possible continuously. The clocking not only causes the step-up and step-downs of the DC output voltage UA, but sinusoidal phase currents iNL1, iNL2, iNL3 are simultaneously extracted from the supply network VN by coupling. With the network circuit 100, a smooth transition between step-down (UA<uN) and step-up (UA>uN) and vice versa is possible, so that the DC output voltage UA can be regulated accordingly in a wide voltage range, for example from 0 volts to 1000 volts, while complying with the PFC standards.

The step-up and step-down in the network circuit 100 is determined by the length of the switch-on duration TE or the short-circuit duration TK. The physical relationships within the network circuit 100 in the control laws shown in FIGS. 12 and 13 lead to a low DC output voltage UA with a short short-circuit duration TK, which results in step-down. Furthermore, a short short-circuit duration TK leads to an improved sinusoidal shape of the phase currents iNL1, iNL2, iNL3 and thus to compliance with the PFC standards. The least harmonic sinusoidal courses of the phase currents iNL1, iNL2, iNL3 are approximately achieved with a short-circuit duration TK less than 0.1 of the switch-on duration TE, or TK<0.1*TE. While a slight change in the short-circuit duration TK with the same switch-on duration TE causes a significant change in the DC output voltage UA, the DC output voltage UA can be fine-tuned or regulated by varying the switch-on duration TE with the same percentage of short-circuit duration TK.

A longer short-circuit duration TK is required for step-up. A longer short-circuit duration TK leads to a sinusoidal shape of the phase currents iNL1, iNL2, iNL3, which deviates from an optimum sinusoidal shape. The least harmonic sinusoidal courses of the phase currents iNL1, iNL2, iNL3 are approximately achieved with a short-circuit duration TK between 0.2 and 0.3 of the switch-on duration TE, or TK=0.2 . . . 0.3*TE. The longer the short-circuit duration TK, the higher the DC output voltage UA is. It is also true for step-up that a slight change in the short-circuit duration TK with the same switch-on duration TE causes a significant change in the DC output voltage UA. In addition, the DC output voltage UA can be finely adjusted or regulated by varying the switch-on duration TE with the same percentage of short-circuit duration TK.

It should be noted that a load connected to the output OUT also has an influence on the switch-on duration TE and short-circuit duration TK. The switch-on duration TE and short-circuit duration TK are therefore generally dependent on the desired DC output voltage UA, the AC power supply voltage uN and the associated dimensioning of the network circuit 100.

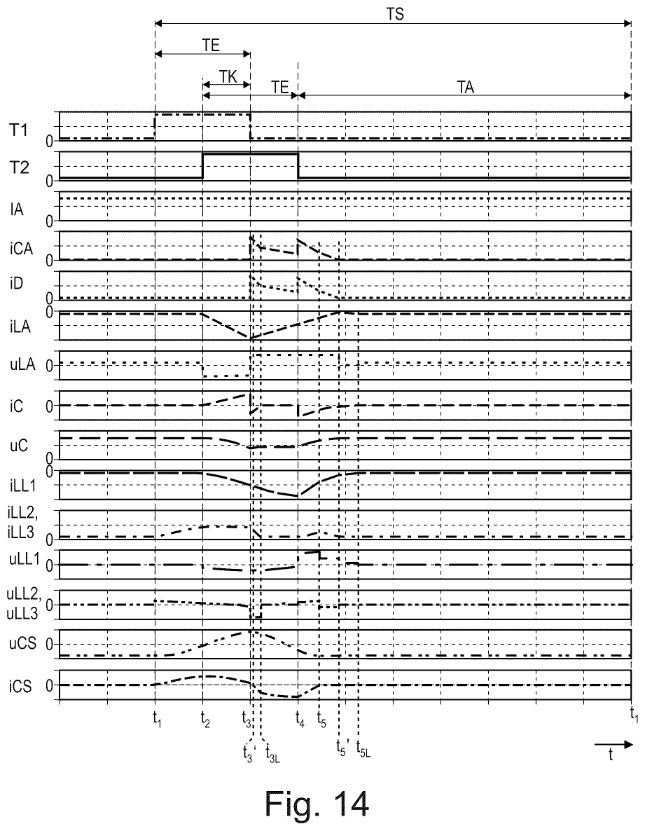

FIGS. 14 to 17 show different characteristic curves based on the control laws according to FIGS. 12 and 13 for the controlling of the first transistor T1 and the second transistor T2 of the network circuit 100 in the steady state according to the first embodiment example according to FIG. 3. For better illustration, the courses of the control signals ST1, ST2 from FIGS. 12 and 13 are also shown in order to determine the points in time for the respective time intervals. The courses of the first control signal ST1 and the second control signal ST2 are not repeated below for the sake of brevity.

Furthermore, the course of the output current IA, the course of the output capacitor current iCA, the course of a diode current iD of the diode D, comprising at least one of the positive diode Dp and negative diode Dn, the course of the output coil current iLA, the course of the output coil voltage uLA, the course of the string capacitor current iC, the course of the string capacitor voltage uC, the course of the coil current iLL1, the course of the coil current iLL23, corresponding to the sum of the coil current iLL2 and iLL3, the course of the coil voltage uLL1, the course of the coil voltage uLL2 and uLL3, which overlap, the course of the capacitor voltage uCS and the course of the capacitor current iCS over time t are shown in FIGS. 14 to 17. The course of the output current IA remains constant greater than zero amperes over the entire period TS.

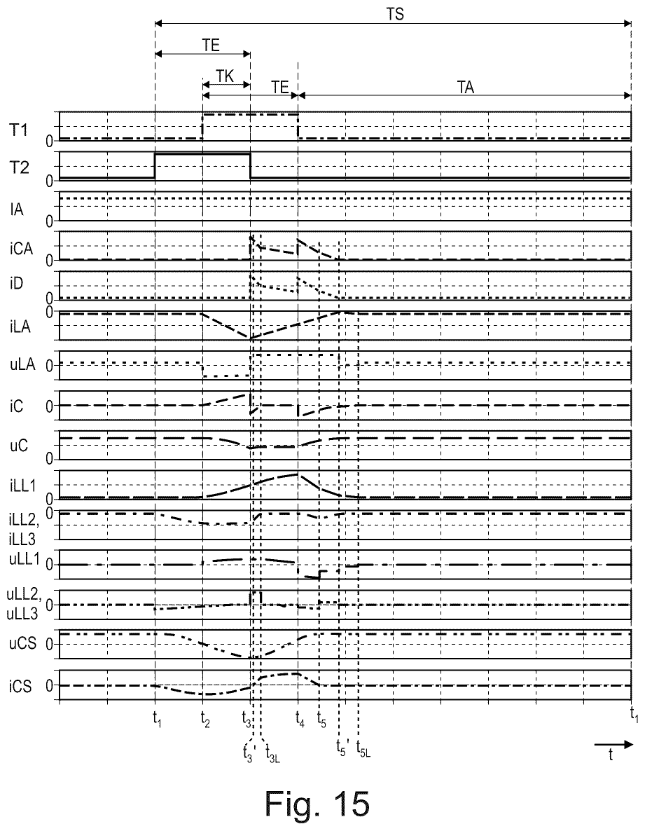

FIGS. 14 and 15 show different characteristic curves, which result in the network circuit 100 according to the first embodiment example due to the positive controlling and the negative controlling for step-up.

FIG. 14 shows essential characteristic curves with positive controlling as a function of the clocking of the first and second transistors T1, T2 of the network circuit 100 when stepping up over the time t. The exemplary assumptions apply that the string voltages u2 and u3 at phases L2 and L3 are equal in terms of amount and greater than 0 volts, while the string voltage u1 at phase L1 is less than 0 volts. Accordingly, the storage chokes LL2 and LL3 are connected to the first transistor T1 via the positive path pZ of the rectifier GR. The rectifier diodes D3 and D5 are conductive. The storage choke LL1, on the other hand, is connected to the second transistor T2 via the negative path nZ of the rectifier GR. The rectifier diode D2 is conductive. These assumptions are exemplary and apply to the characteristic curves described below, in which the AC power supply voltages of two phases are greater than zero. The selected assumptions are not intended to limit the scope of the invention and could be made in other ways.

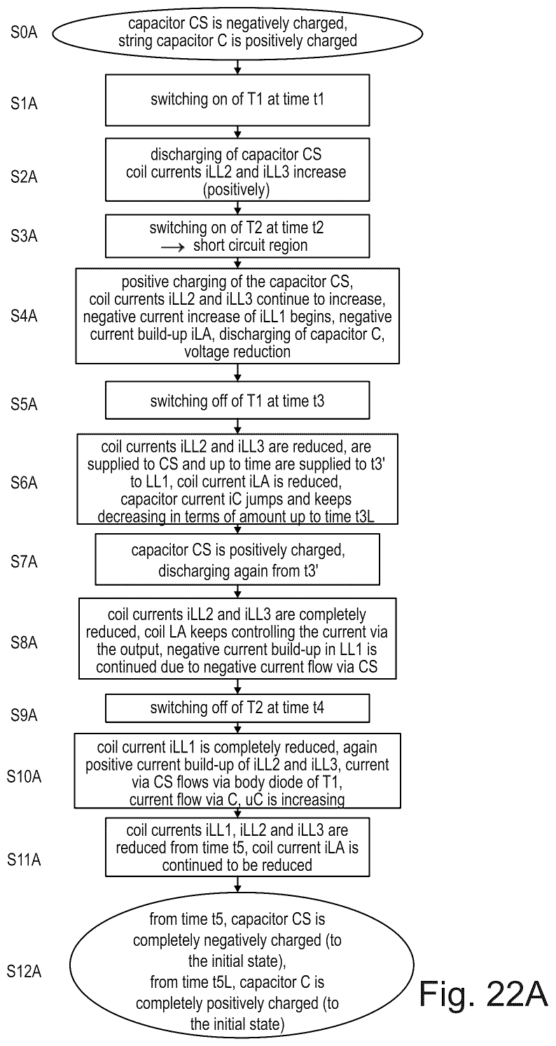

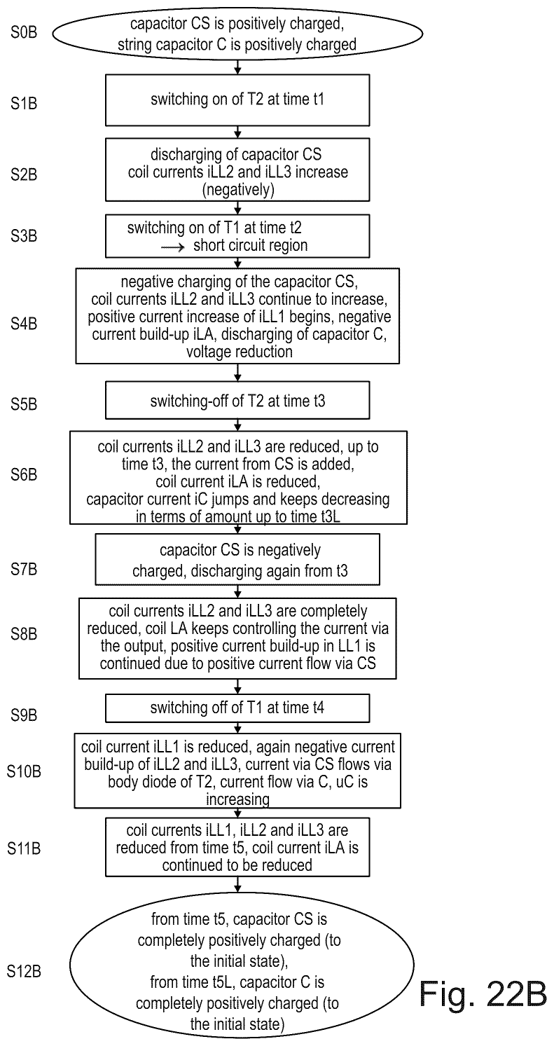

With additional reference to FIG. 22A, the capacitor CS is negatively charged (uCS<0) and the string capacitor C is positively charged (uC>0) at the beginning of step S0A of the period duration TS at the first time t1. At the first time t1, in step S1A, the first transistor T1 is conducting or switched on. As a result, the voltage difference resulting from the AC power supply voltage uN of the respective phase and the capacitor voltage uCS is present as coil voltages uLL2 and uLL3 at the storage chokes LL2 and LL3. The values of the coil voltages uLL2 and uLL3 are correspondingly greater in terms of amount than the values of the AC power supply voltages uN of phases L2 and L3 relative to the zero potential. As a result, a current begins to build up in the storage chokes LL2 and LL3 in step S2A, causing the coil currents iLL2 and iLL3 to increase positively. The positively increasing capacitor current iCS discharges the capacitor CS to the capacitor voltage uCS=0V. The coil current iLL23, as the sum of the coil currents iLL2 and iLL3 of the storage chokes LL2 and LL3, increases positively in correspondence with the capacitor current iCS up to the second time t2.

At the second time t2, the second transistor T2 becomes conductive in step S3A, while the first transistor T1 is also conductive. The second transistor T2 is triggered as conducting by the control unit SE when a set time period has elapsed or alternatively when the capacitor voltage uCS equals zero volts. As a result, the rectifier GR is short-circuited for the short-circuit duration TK, which corresponds to the short-circuit range shown in FIGS. 12 and 13. In step S4A, from this second time t2, the capacitor CS is positively charged starting from the discharged state, wherein the capacitor current iCS decreases in terms of amount from the second time t2 (tends towards zero). Meanwhile, the coil currents iLL2 and iLL3 in the storage chokes LL2 and LL3 continue to build up positively or continue to increase positively during the short-circuit duration TK.

When the second transistor T2 is controlled, the voltage difference between the AC power supply voltage uN of phase L1 and the current value of the capacitor voltage uCS as the coil voltage uLL1 is applied to the storage choke LL1. The value of the coil voltage uLL1 is correspondingly greater (negative) in terms of amount than the value of the AC power supply voltage uN of phase L1 in relation to the zero potential. Accordingly, a negative current build-up of the coil current iLL1 begins in the storage choke LL1 from this time.

Due to the short circuit via the transistors T1, T2, a negative output coil voltage uLA is applied to the output coil LA. Accordingly, a negative output coil current iLA builds up in the output coil LA during the short-circuit duration TK. Due to the negative increase in terms of amount of the output coil current iLA, a positive flow of a string capacitor current iC into the string capacitor C occurs, whereby the string capacitor C begins to discharge from the second time t2. Accordingly, a string capacitor voltage uC of the string capacitor C decreases in terms of amount.

During this period, the main part of the energy input into the network circuit 100 takes place. The second transistor T2 can either be controlled or alternatively controlled when the capacitor voltage uCS becomes zero volts.

At the third time t3, in step S5A, the first transistor T1, which is conducting at time t1, is switched off again or made non-conducting by the control unit SE after the switch-on duration TE. The second transistor T2 remains conductive. From the third time t3, the storage chokes LL2 and LL3, in which the positive coil currents iLL2, iLL3 have built up during the switch-on duration TE of the first transistor T1, control these coil currents iLL2, iLL3 on the input side via the rectifier diodes D3, D5, the string capacitor C and on the output side via the diode D, comprising at least one of the positive diode Dp and the negative diode Dn, and the load path or output OUT. Accordingly, the coil currents iLL2 and iLL3 in the storage chokes LL2 and LL3 are reduced again in step S6A. Since the second transistor T2 is still conducting at this point, the sum of the coil currents from iLL2, iLL3 after the load path is briefly divided at the node below the second transistor T2 between the storage choke LL1, in which the coil current iLL1 continues to build up, and the capacitor CS. The capacitor current iCS decreases more strongly from time t3.

When the first transistor T1 is switched off, the previously negative output coil voltage uLA (uLA<0 V) at the output coil LA jumps to positive (uLA>0 V). Accordingly, the negative output coil current iLA built up in the output coil LA begins to decrease again in the direction of zero amperes.

The string capacitor current iC of the string capacitor C changes abruptly from a value greater than zero amperes (iC>0) to a value less than zero amperes (iC<0) due to the reduction of the output coil current iLA in the output coil LA and decreases in terms of amount from the third time t3 up to time t3L. Accordingly, the string capacitor voltage uC increases in terms of amount from the third time t3.

The maximum positive capacitor voltage uCS is reached at time t3′ when the capacitor current iCS equals zero amperes, or iCS=0 A. From this time t3′ in step S7A, a negative flow of the capacitor current iCS across the capacitor CS is established. From time t3′, the capacitor CS is discharged up to a fifth time t5 and charged negatively again. From time t3′, the negative capacitor current iCS is added to the flow of the sum of the coil currents iLL2, iLL3 of the storage chokes LL2 and LL3 to the storage choke LL1.

The output capacitor CA is charged with energy after the first transistor T1 is switched off at time t3 up to time t5L, when the energy stored in the storage chokes LL1, LL2, LL3 is completely dissipated. During the remaining period TS, the energy stored in the output capacitor CA is transferred to the load connected to the output OUT.

With step S8A at time t3L, the coil currents iLL2 and iLL3 in the storage chokes LL2 and LL3 are completely dissipated. The coil currents iLL2 and iLL3 correspond to zero amperes at time t3L. The output coil current iLA in the output region B2 of the network circuit 100 is completely controlled by the output coil LA from time t3L, wherein the negative output coil current iLA continues to decrease in terms of amount. Consequently, no current flows between input IN and output OUT of the network circuit 100 and thus no more current flows through the string capacitor C. The string capacitor voltage uC remains at a constant value up to time t4. The total negative capacitor current iCS continues to flow via the storage choke LL1 from time t3L, as a result of which the coil current iLL1 continues to increase negatively in terms of amount.

At the fourth time t4, the second transistor T2, which is still conducting, is controlled by the switching unit SE after the switch-on duration TE in such a way that the second transistor T2 becomes non-conducting. From the fourth time t4, the storage choke LL1 controls the coil current iLL1 again via the string capacitor C, the diode D, comprising at least one of the positive diode Dp and the negative diode Dn, and the load connected to the output of the network circuit 100, wherein the coil current iLL1 is added to the output coil current iLA of the output coil LA, which continues to decay. From the fourth time t4, the capacitor current iCS flows via the only remaining current path in the form of the body diode of the first transistor T1 (or a freewheeling diode connected in parallel thereto) and decreases again in terms of amount from the fourth time t4. As a result, the capacitor voltage uCS of the capacitor CS is charged to its original negative value, as it was before the first time t1. At the same time, positive coil currents iLL2 and iLL3 begin to build up again in the two storage chokes LL2 and LL3.

Due to the coil current iLL1 controlled by the storage choke LL1 via the output OUT, a current flows again in step S10A between input IN and output OUT of the network circuit 100 and thus a current flows through the string capacitor C. The string capacitor current iC jumps from a value of 0 amperes to a negative value (iC<0 A) at the fourth time t4 and decreases in terms of amount from the fourth time t4. Accordingly, the capacitor voltage uC increases in terms of amount from the fourth time t4.

At the fifth time t5, in step S11A, the value of the coil current iLL1 of the storage choke LL1 corresponds to the sum of the value of the coil currents iLL2 and iLL3 of the storage chokes LL2 and LL3. This makes the capacitor current iCS equal to zero amperes or iCS=0 A. As a result, no more current flows through the freewheeling diode of the first transistor T1 from the fifth time t5. From this fifth time t5, in step S12A, the capacitor CS is fully charged to the negative initial value of the capacitor voltage uCS, which is available again for the next period duration TS. The storage chokes LL1, LL2, LL3 continue to control the current via the output OUT, wherein the current is added to the output coil current iLA of the output coil LA up to time t5′. The remaining coil currents iLL1, iLL2, iLL3 decrease linearly with time up to time t5L.

At time t5L, the output coil current iLA of the output coil LA is completely dissipated, as are the coil currents iLL1, iLL2, iLL3 of the storage chokes LL1, LL2, LL3. As a result, no more current flows between input IN and output OUT of the network circuit 100 and therefore no more string capacitor current iC flows through the string capacitor C. From the time t5L, the string capacitor voltage uC is fully charged to the positive value that is available again for the next period TS.

The value of the coil currents iLL1=iLL2=iLL3=0 at time t5L can be reached either before the end of the period duration TS in discontinuous conduction mode or at the end of the period duration TS in boundary conduction mode. The value of the output coil current iLA=0 at time t5′ can also be reached either before the end of the period duration TS or at the end of the period duration TS. This has no effect on the operation of the network circuit 100 with regard to boundary conduction mode or discontinuous conduction mode.

In boundary conduction mode, one of the coil currents iLL1, iLL2, iLL3 becomes zero amperes exactly at the end of a period TS. In discontinuous conduction mode, a pause is inserted between the current reduction and the start of the new period duration TS (the current “discontinues” or has a discontinuity). Discontinuous conduction mode and boundary conduction mode are standard when using step-up converters.

FIG. 15 shows essential characteristic curves for negative controlling as a function of the clocking of the first and second transistors T1, T2 of the network circuit 100 during step-up over the time t. The exemplary assumptions apply that the string voltage u1 of phase L1 is greater than zero volts, while the string voltages u2 and u3 of phases L2 and L3 are of equal in terms of amount and less than zero volts. Accordingly, the storage choke LL1 is connected to the first transistor T1 via the positive path pZ of the rectifier GR. The rectifier diode D1 is conductive. The storage chokes LL2 and LL3, on the other hand, are connected to the second transistor T2 via the negative path nZ of the rectifier GR. The rectifier diodes D4 and D6 are conductive. These assumptions are exemplary and apply to the characteristic curves described below, in which the network voltages of two phases are less than zero. The selected assumptions are not intended to limit the scope of the invention and could be made in other ways.

With additional reference to FIG. 22B, at the beginning of step SOB, the capacitor CS is positively charged (uCS>0) and the string capacitor C is also positively charged (uC>0). At the first time t1, in step S1B, the second transistor T2 is conducting or switched on. As a result, the voltage difference resulting from the AC power supply voltage uN of the respective phase and the capacitor voltage uCS is applied as coil voltages uLL2 and uLL3 to the storage chokes LL2 and LL3. The values of the coil voltages uLL2 and uLL3 are correspondingly greater in terms of amount than the values of the AC power supply voltages uN of phases L2 and L3 relative to the zero potential. As a result, a current begins to build up in the storage chokes LL2 and LL3 in step S2B, causing the coil currents iLL2 and iLL3 to increase negatively. The capacitor CS is discharged to the capacitor voltage uCS=0V by the negatively increasing capacitor current iCS. The coil currents iLL2 and iLL3 of the storage chokes LL2 and LL3 increase negatively in correspondence with the capacitor current iCS up to the second time t2.

At the second time t2, in step S3B, the first transistor T1 becomes conductive while the second transistor T2 is also conductive. As a result, the rectifier GR is short-circuited for the short-circuit duration TK, which corresponds to the short-circuit range shown in FIGS. 12 and 13. In step S4B, from this second time t2, the capacitor CS is negatively charged starting from the discharged state, with the capacitor current iCS decreasing in terms of amount (heading towards zero) from the second time t2.

By controlling the first transistor T1, the voltage difference resulting from the AC power supply voltage uN of phase L1 and the current value of the capacitor voltage uCS as the coil voltage uLL1 is applied to the storage choke LL1.

The value of the coil voltage uLL1 is therefore greater in terms of amount (positive) than the value of the AC power supply voltage uN of phase L1 in relation to the zero potential. Accordingly, a positive current build-up of the coil current iLL1 begins in the storage choke LL1 from this time.

Due to the short circuit via the transistors T1, T2, a negative output coil voltage uLA is applied to the output coil LA. Accordingly, a negative output coil current iLA builds up in the output coil LA during the short-circuit duration TK. Due to the negative increase in the magnitude of the output coil current iLA, a positive flow of a string capacitor current iC into the string capacitor C occurs, whereby the string capacitor C begins to discharge from the second time t2. Accordingly, a string capacitor voltage uC of the string capacitor C decreases in terms of amount.

During this period, the main part of the energy input into the network circuit 100 takes place. The controlling of the first transistor T1 can optionally be controlled or alternatively take place when the capacitor voltage uCS becomes zero volts.

At the third time t3, in step S5B, the second transistor T2, which is conducting at time t1, is switched off again by the control unit SE after the switch-on duration TE. The first transistor T1 remains conductive. From the third time t3, the storage chokes LL2 and LL3, in which the negative coil currents iLL2 and iLL3 have built up during the switch-on duration TE of the second transistor T2, control these coil currents iLL2 and iLL3 on the input side via the rectifier diodes D4, D6, the string capacitor C and on the output side via the diode D, comprising at least one of the positive diode Dp and the negative diode Dn, and the load path. Accordingly, in step S6B, the coil currents iLL2 and iLL3 in the storage chokes LL2 and LL3 are reduced again. As the first transistor T1 is still conducting at this time, a positive current is briefly added to the sum of the coil currents from iLL2 and iLL3 upstream of the node above the first transistor T1 due to the negative flow of the capacitor current iCS through the capacitor CS. The capacitor current iCS increases more strongly from time t3.

When the second transistor T2 is switched off, the previously negative output coil voltage uLA (uLA<0 V) at the output coil LA jumps to positive (uLA>0 V). Accordingly, the negative output coil current iLA built up in the output coil LA begins to decrease again in the direction of zero amperes.

The string capacitor current iC of the string capacitor C changes abruptly from a value greater than zero amperes (iC>0) to a value less than zero amperes (iC<0) due to the reduction of the output coil current iLA in the output coil LA and decreases in terms of amount from the third time t3 up to the time t3L. Accordingly, the string capacitor voltage uC increases in terms of amount from the third time t3.

The maximum positive capacitor voltage uCS is reached at time t3′ when the capacitor current iCS equals zero amperes, or iCS=0 A. From this time t3′, in step S7B, a positive capacitor current iCS is established via the capacitor CS. The capacitor CS is discharged again. The positive capacitor current iCS of the capacitor CS is subtracted from the coil current iLL1 of the storage choke LL1 from time t3′. The remaining current flows to the coils LL2 and LL3.

With step S8B at time t3L, the coil currents iLL2 and iLL3 of the storage chokes LL2 and LL3 are completely reduced. The coil current iLL23 corresponds to zero amperes at time t3L. The output coil current iLA in the output region B2 of the network circuit 100 is completely controlled by the output coil LA from time t3L, wherein the negative output coil current iLA continues to decrease in terms of amount. Consequently, no current flows between input IN and output OUT of the network circuit 100 and thus no more current flows through the string capacitor C. The string capacitor voltage uC remains at a constant value up to time t4. The total positive capacitor current iCS continues to flow via the storage choke LL1 from time t3L, as a result of which the coil current iLL1 continues to increase positively in terms of amount.

At the fourth time t4, in step S9B, the still conducting first transistor T1 is controlled by the switching unit SE in such a way that the first transistor T1 becomes non-conducting, after the switch-on duration TE. From the fourth time t4, the storage choke LL1 controls the coil current iLL1 again via the string capacitor C, the diode D, comprising at least one of the positive diode Dp and the negative diode Dn, and the load connected to the output of the network circuit 100, wherein the coil current iLL1 is added to the output coil current iLA of the output coil LA, which continues to decay. From the fourth time t4, the capacitor current iCS flows via the only remaining current path in the form of the body diode of the second transistor T2 (or a freewheeling diode connected in parallel), which is switched off first, and its value decreases again in terms of amount from the fourth time t4. As a result, the capacitor voltage uCS of the capacitor CS is charged to its original positive value, as it was before the first time t1. At the same time, negative coil currents iLL2 and iLL3 begin to build up again in the two storage chokes LL2 and LL3.

Due to the coil current iLL1 controlled by the storage choke LL1 via the output OUT, a current flows again in step S10B between input IN and output OUT of the network circuit 100 and thus a current flows through the string capacitor C. The string capacitor current iC jumps from a value of 0 amperes to a negative value (iC<0 A) at the fourth time t4 and decreases in terms of amount from the fourth time t4. Accordingly, the capacitor voltage uC increases in terms of amount from the fourth time t4.

At the fifth time t5, in step S11B, the amount of the coil current iLL1 of the storage choke LL1 corresponds to the sum of the amount of the coil currents iLL2 and iLL3 of the storage chokes LL2 and LL3. This makes the capacitor current iCS equal to zero amperes or iCS=0 A. As a result, no more current flows through the freewheeling diode of the second transistor T2 from the fifth time t5. From this fifth time t5, in step S12B, the capacitor CS is fully charged to the positive initial value of the capacitor voltage uCS, which is available again for the next period duration TS. The storage chokes LL1, LL2, LL3 continue to control the current via the output OUT, wherein the current is added to the output coil current iLA of the output coil LA up to time t5′. The remaining coil currents iLL1, iLL2, iLL3 decrease linearly with time up to time t5L.

At time t5L, the output coil current iLA of the output coil LA is completely dissipated, as are the coil currents iLL1, iLL2, iLL3 of the storage chokes LL1, LL2, LL3. Consequently, no more current flows between input IN and output OUT of the network circuit 100 and therefore no more string capacitor current iC flows through the string capacitor C. The string capacitor voltage uC is fully charged to the positive value from the time t5L, which is available again for the next period TS.

The value of the coil currents iLL1=iLL2=iLL3=0 at the time t5L can be reached either before the end of the period duration TS in discontinuous conduction mode or at the end of the period duration TS in boundary conduction mode. The value of the output coil current iLA=0 at time t5′ can also be reached either before the end of the period duration TS or at the end of the period duration TS. This has no effect on the operation of the network circuit 100 with regard to boundary conduction mode or discontinuous conduction mode.

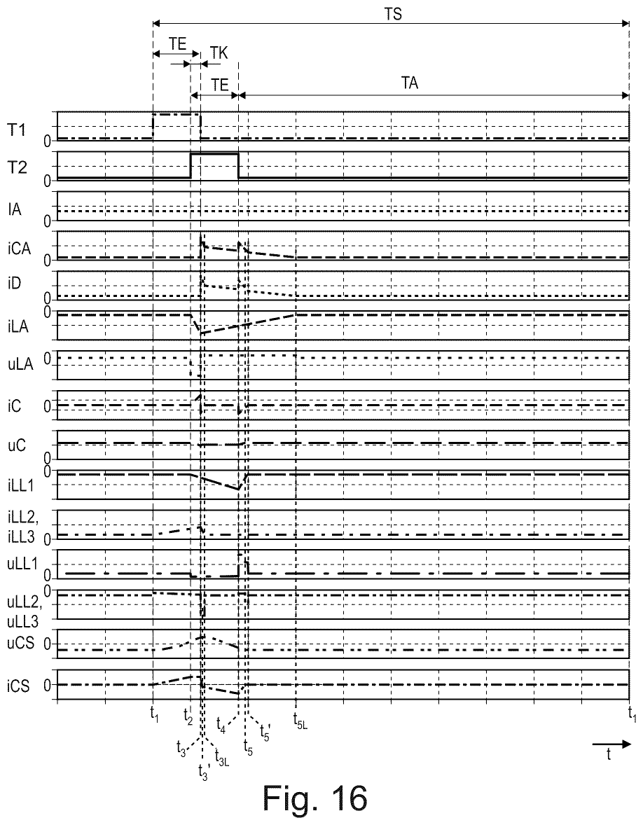

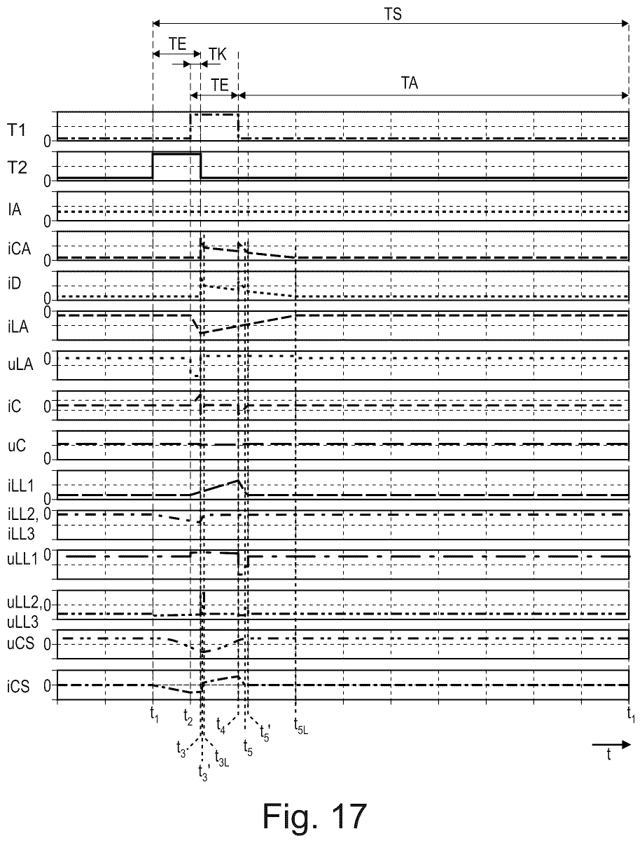

FIGS. 16 and 17 show different characteristic curves, which result in the network circuit 100 according to the first embodiment example due to the positive controlling and the negative controlling for the step-down.

The courses of the characteristic curves in FIGS. 16 and 17 for the step-down differ from the courses of the characteristic curves for the step-up in FIGS. 14 and 15 only in that the length of the individual time intervals between the individual times t1, t2, t3, t3′, t3L, t4, t5, t5′, t5L differ due to the different ratios of the short-circuit duration TK to the switch-on duration TE.

Due to the different ratios of the short-circuit duration TK to the switch-on duration TE during positive controlling and negative controlling of the first transistor T1 and the second transistor T2 of the network circuit 100 according to the first embodiment example during step-up (TK=0.2 . . . 0.3*TE), and at the step-down (TK<0.1*TE), a larger or smaller DC output voltage UA can be generated from an AC power supply voltage uN with the present network circuit 100 without additional or downstream circuitry.

The positive controlling and negative controlling for step-up and step-down the network circuit 100 according to the first embodiment example as shown in FIGS. 14 to 17 can also be used in an analogous manner for the positive controlling and negative controlling for step-up and step-down the network circuit 100 according to the second embodiment example.

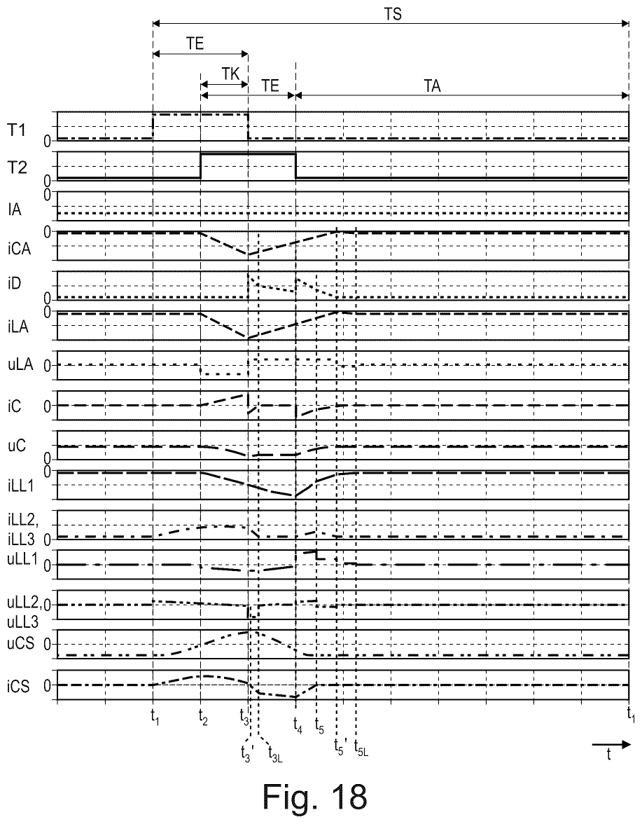

FIGS. 18 to 21 show different characteristic curves based on the control laws according to FIGS. 12 and 13 for the controlling of the first transistor T1 and the second transistor T2 of the network circuit 100 in the steady state according to the second embodiment example according to FIG. 5. For better illustration, the courses of the control signals ST1, ST2 from FIGS. 12 and 13 are also shown in order to determine the points in time for the respective time intervals.

Furthermore, the course of the output current IA, the course of the output capacitor current iCA, the course of a diode current iD of the diode D, comprising at least one of the positive diode Dp and negative diode Dn, the course of the output coil current iLA, the course of the output coil voltage uLA, the course of the string capacitor current iC, the course of the string capacitor voltage uC, the course of the coil current iLL1, the course of the coil currents iLL2, iLL3, the course of the coil voltage uLL1, the course of the coil voltages uLL2, uLL3, the course of the capacitor voltage uCS and the course of the capacitor current iCS over the time t is shown in FIGS. 18 to 21.

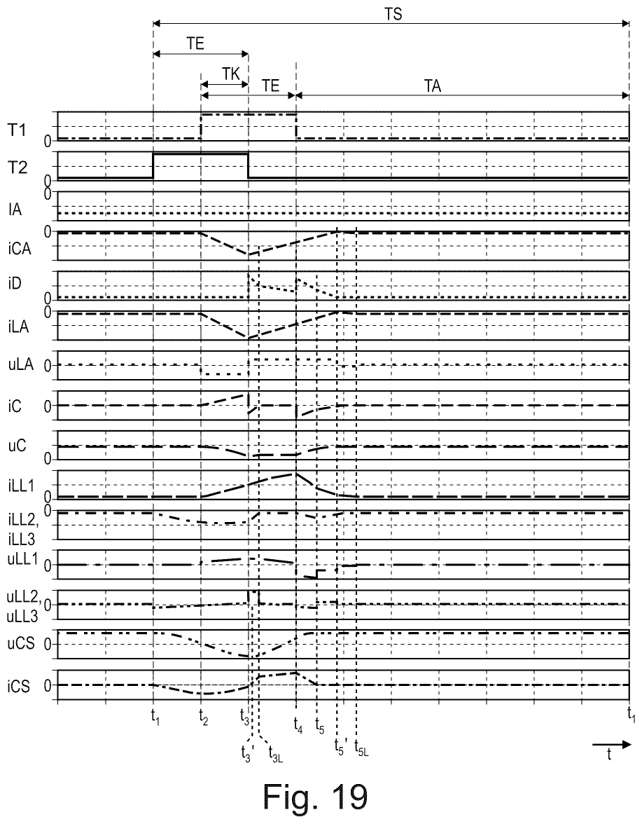

FIGS. 18 and 19 show different characteristic curves which result in the network circuit 100 according to the second embodiment example due to the positive controlling and the negative controlling for step-up. The courses of all characteristic curves except for those of the output current IA and the output capacitor current iCA are identical to the courses of the characteristic curves of the network circuit 100 according to the first embodiment example as shown in FIGS. 14 and 15 and are therefore not repeated again for the sake of brevity.

The output current IA remains constant at less than zero amperes over the entire period TS.

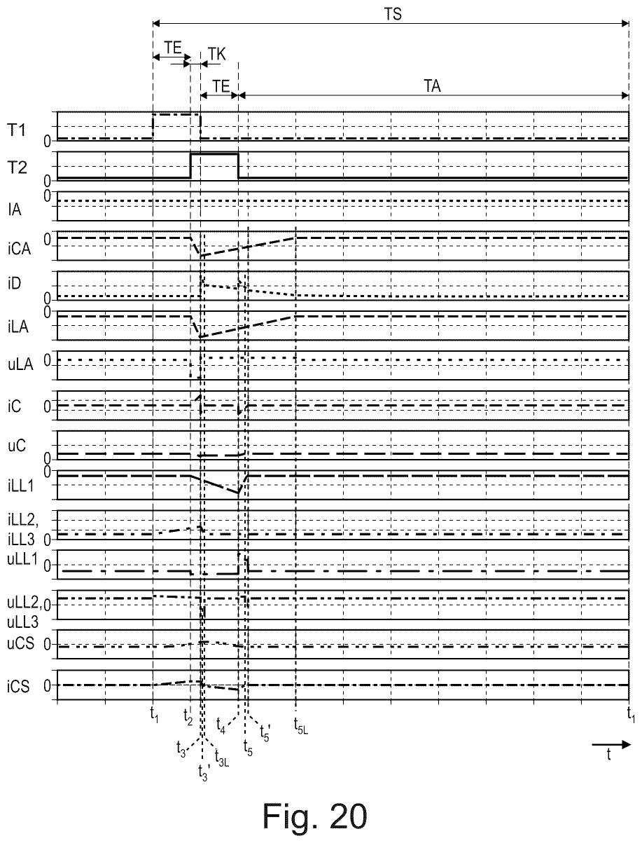

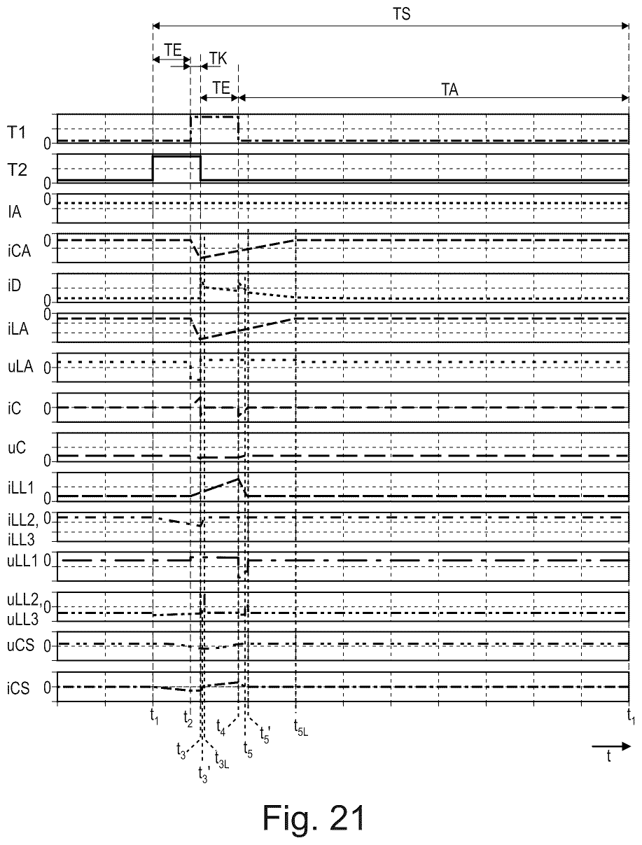

FIGS. 20 and 21 show different characteristic curves which result in the network circuit 100 according to the second embodiment example due to the positive controlling and the negative controlling for the step-down. The courses of all characteristic curves except for those of the output current IA and the output capacitor current iCA are identical to the courses of the characteristic curves of the network circuit 100 according to the first embodiment example as shown in FIGS. 16 and 17 and are therefore not repeated again for the sake of brevity.

FIGS. 22A and 22B illustrate the method of positive controlling (FIG. 22A) and the method of negative controlling (FIG. 22B) of the first transistor T1 and the second transistor T2 of the network circuit 100. These methods are based on the controlling or clocking described above and accordingly apply to the step-up and step-down respectively for the network circuit 100 according to the first embodiment example (non-inverting) and for the network circuit 100 according to the first embodiment example (inverting) in an analogous way.

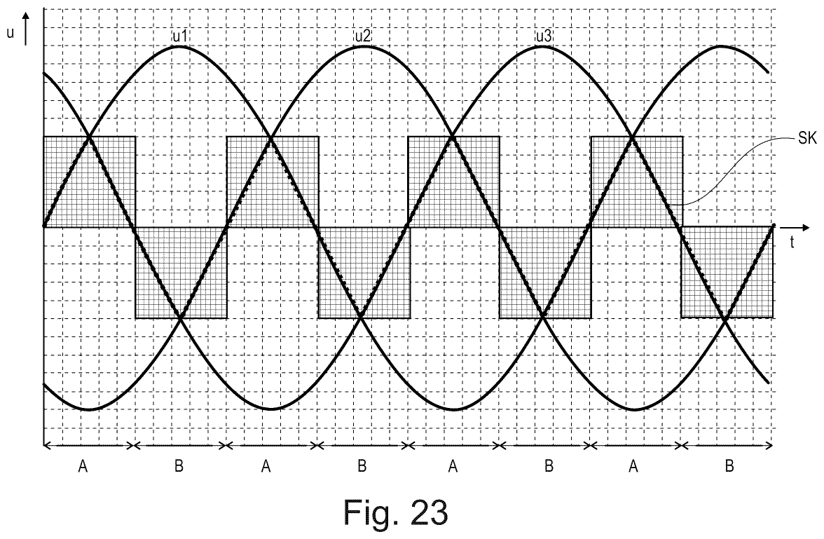

FIG. 23 illustrates a supply network VN as a three-phase system with string voltages u1, u2, u3 and time intervals A, B. The polarity of the capacitor charge and the capacitor voltage uCS of the capacitor CS must be taken into account so that the network circuit 100 can fulfill the step-up and step-down functions as desired while complying with the PFC standards.

Looking at the progression of the string voltages u1, u2, u3 of the three-phase system, there are positive time intervals A, in which two string voltages are greater than zero and one string voltage is less than zero, and negative time intervals B, in which one string voltage is greater than zero and two string voltages are less than zero. If two of the string voltages u1, u2, u3 are greater than zero, positive controlling (see FIG. 12) is used in this positive time interval A. If two of the string voltages u1, u2, u3 are less than zero, negative controlling (see FIG. 13) is used in this negative time interval B. Over time, an approximate triangular voltage curve SK (dashed line) of sine segments is obtained, which is defined by the time intervals A, B and runs around the zero line.

For the time intervals A, B, i.e. the time at which the positive controlling or the negative controlling is active, the string voltages u1, u2, u3 are always in the same state, i.e. greater than zero or less than zero. For the time intervals A, B, it can therefore be defined on the basis of the symmetrical three-phase system that time interval A=time interval B.

At each zero point of the approximately triangular voltage curve SK, there is a change from the positive controlling to the negative controlling or from the negative controlling to the positive controlling. If the approximately triangular voltage curve SK runs from the negative time interval B, i.e. with a value less than zero, into the positive time interval A, i.e. with a value greater than zero, the controlling changes from a negative controlling to a positive controlling. The transition from positive/negative controlling to negative/positive controlling can, for example, take place abruptly, as shown in FIG. 22. However, the transition can also be smooth (not shown).

The duration of the time intervals A, B depends on the network frequency fN. In the European supply network with a network frequency of fN=50 Hz, a zero point occurs every 3.33 milliseconds in the three-phase system. This means that the system switches between positive and negative controlling every 3.33 milliseconds. However, the network circuit 100 is not limited to the European supply network. In fact, the network circuit 100 can be put into operation for all international network voltages and frequencies.

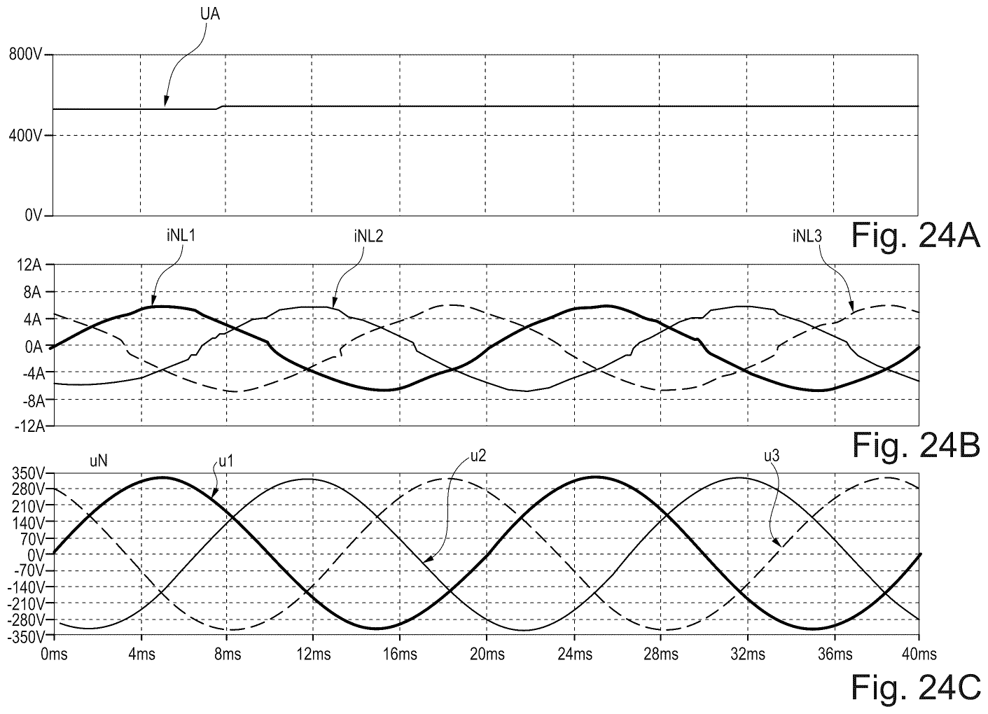

By charging the capacitor voltage uCS, a voltage difference between the string voltages u1, u2, u3 and the capacitor voltage uCS at the storage chokes LL1, LL2, LL3 can be influenced in such a way that greater coil voltages uLL1, uLL2, uLL3 are applied to the storage chokes LL1, LL2, LL3 than can be physically obtained from the supply network VN, depending on the controlling of the first and second switching transistors T1, T2 by the control unit SE. In other words, the phase currents iNL1, iNL2, iNL3 are modulated by the coil voltages uLL1, uLL2, uLL3, which are influenced by the adjustable voltage applied to the capacitor CS. As illustrated in FIGS. 23 and 24B, this results in sinusoidal network currents iNL1, iNL2, iNL3, which are provided at the input of the rectifier GR in order to meet the limit values of the PFC standards in the corresponding power classes.

In all the embodiment examples described, the first transistor T1 and the second transistor T2 are controlled in such a way that the DC output voltage UA is regulated to a desired value depending on the load, with at least one of the switch-on duration TE, the short-circuit duration TK and the off-duration TA of the first and second transistors T1, T2 serving as degrees of freedom. As a result, in addition the controlling not only lowers or raises the DC output voltage UA, but also complies with the limit values for harmonic currents of the PFC standards, which increases the effectiveness and energy efficiency of the network circuit and reduces the number of components and thus the costs.

FIGS. 24A, 24B and 24C show determined courses of the network variables of the network circuit 100 according to the first embodiment example during step-up. FIG. 24A shows the course of the DC output voltage UA, FIG. 24B shows the course of the sinusoidal phase currents iNL1, iNL2, iNL3, and FIG. 24C shows the course of the AC power supply voltage uN comprising the string voltages u1, u2, u3. A step-up to a positive DC output voltage UA takes place with sinusoidal PFC-compliant current extraction.

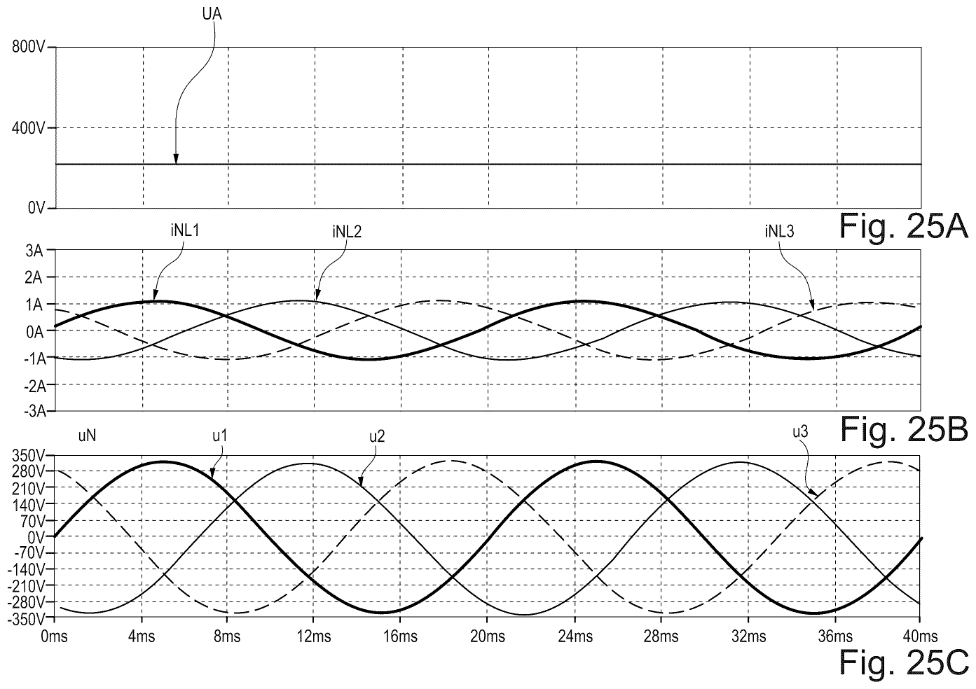

FIGS. 25A, 25B and 25C illustrate determined courses of the network variables of the network circuit 100 according to the first embodiment example during step-down. FIG. 25A shows the course of the DC output voltage UA, FIG. 25B shows the course of the sinusoidal phase currents iNL1, iNL2, iNL3, and FIG. 25C shows the course of the AC power supply voltage uN comprising the string voltages u1, u2, u3. A step-down to a positive DC output voltage UA takes place with sinusoidal PFC-compliant current extraction.

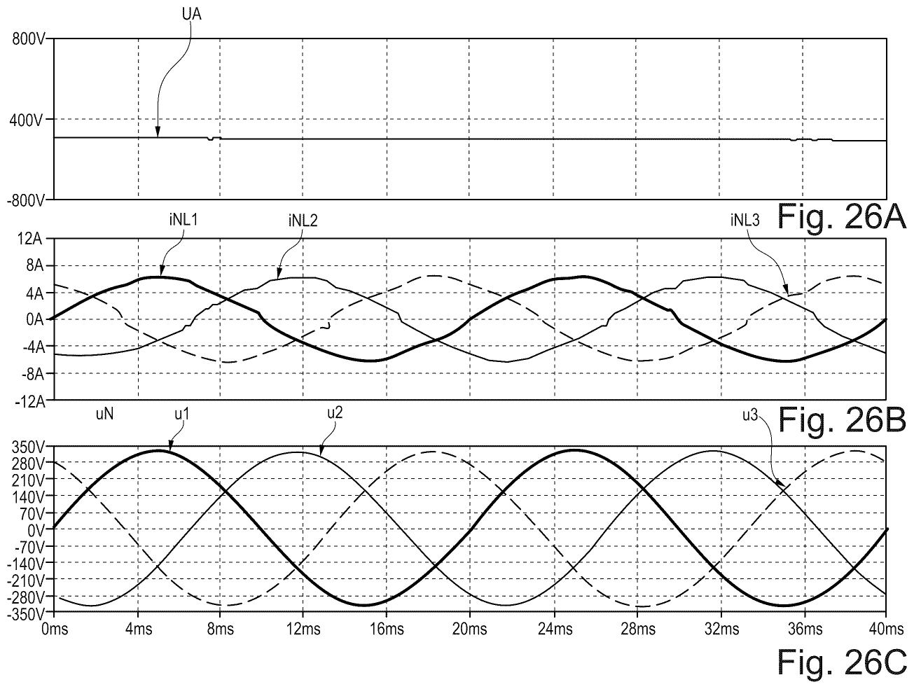

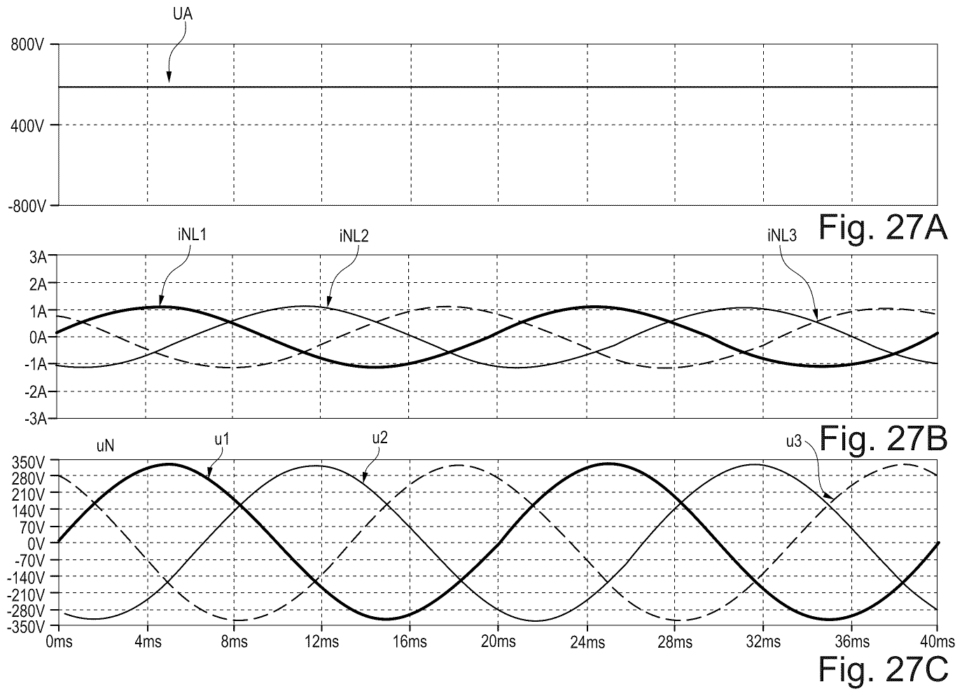

FIGS. 26A to 27C illustrate determined network variables of the network circuit 100 according to the second embodiment example for the step-up and step-down in an analogous manner to the courses of the network variables according to FIGS. 24A to 25C. FIG. 26A shows a step-up to a negative DC output voltage UA with sinusoidal PFC-compliant current extraction. FIG. 27A shows a step-down to a positive DC output voltage UA with sinusoidal PFC-compliant current extraction.

### LIST OF REFERENCE SIGNS

100 network circuit
A, B time interval
AE output detection
ON control input
C String capacitor
CA output capacitor
CS capacitor
CYL1, CYL2, CYL3 star capacitors
D diode
D1-D6 rectifier diodes
Dn negative diode
Dp positive diode
e1, e2, e3 inputs
EMI electromagnetic filter (filter against electromagnetic interference)
fN network frequency
GR rectifier
IA output current
iC string capacitor current
iCS capacitor current
iNL1, iNL2, iNL3 phase currents
KS coupling circuit
KS coupling circuit
L1, L2, L3 phases
LL1, LL2, LL3 storage chokes
M midpoint
NE network detection
SE control unit
SK voltage curve
SP star point
T1 first transistor

T2 second transistor

TE switch-on duration

TC short circuit duration

TS period duration
u1, u2, u3 string voltages

UA DC output voltage
uCS capacitor voltage
VN supply network

What is claimed is:

1. A PFC network circuit with a half-bridge for converting an AC power supply voltage to both a lower and a higher DC output voltage in compliance with PFC standards, the network circuit comprising:
three phases;
a rectifier comprising three inputs;
a first and a second transistor, controlled by a control unit;
a midpoint which is arranged between the first and second transistor;
a star point comprising three star capacitors;
a capacitor connected to the midpoint and a reference potential, which can be either the zero potential of the network circuit or the star point of the star capacitors;
an output capacitor, an output coil, a diode and a string capacitor, wherein the output capacitor, the output coil, the diode and the string capacitor are provided at an output region of the network circuit; and
three storage chokes, each of which is connected to one of the three phases and one of the three inputs of the rectifier;
wherein the capacitor is configured to serve as an adjustable voltage source by selectively charging and discharging by controlling the first and second transistors and to adjust a voltage difference across the three storage chokes in order to meet PFC standards; and
wherein the control unit is arranged to control the first transistor and the second transistor so as to convert an AC power supply voltage into a stepped-up or stepped-down DC output voltage depending on a polarity of string voltages; and
wherein controlling of the first and second transistors is conducted by the control unit by positive and negative controlling.

2. The PFC network circuit according to claim 1, wherein
the diode comprises at least one of a positive diode in the positive path, a negative diode in the negative path, or the positive diode in the positive path and the negative diode.

3. The PFC network circuit according to claim 1, wherein
the string capacitor comprises at least one of a positive-strand capacitor in the positive string, a negative-strand capacitor in the negative string or the positive-strand capacitor in the positive string and the negative-strand capacitor in the negative string.

4. The PFC network circuit according to claim 1, wherein
the output coil comprises at least one of a positive output coil in the positive path, a negative output coil in the negative path or the positive output coil in the positive path and the negative output coil.

5. The PFC network circuit according to claim 1, further comprising
a positive decoupling diode, provided at the output region of the network circuit in the positive path and a negative decoupling diode, provided at the output region of the network circuit in the negative path.

6. The PFC network circuit according to claim 1, wherein
the network circuit is formed as multi-channel.

7. The PFC network circuit according to claim 6, in which
the channels of the multi-channel network circuit can be operated synchronously or offset according to the interleave principle.

8. A method of converting an AC power supply voltage to both a lower and a higher DC output voltage while complying with PFC standards on a network circuit, the method comprising:
controlling of a first and a second transistor;
charging and discharging the capacitor depending on the controlling;
generating a capacitor voltage in the capacitor;
influencing a voltage difference at three storage chokes by the capacitor voltage of the capacitor; and
extracting sinusoidal phase currents from a supply network, wherein limit values for harmonic currents of the PFC standard are complied with;
wherein the controlling comprises a positive and a negative controlling and takes into account a polarity of string voltages;
wherein coil voltages of the storage chokes correspond to the voltage differences between the capacitor voltage and the respective AC power supply voltage as a result of charging and discharging; and
wherein the DC output voltage is stepped up or down with respect to the AC power supply voltage depending on the controlling.

9. The method according to claim 8, wherein
the first transistor and second transistor are controlled in such a way that the DC output voltage is regulated to a desired value depending on the load, with at least one of a switch-on duration, a short-circuit duration and a switch-off duration of the first and second transistors serving as degrees of freedom.

10. The method according to claim 8, wherein
the controlling is carried out in such a way that limit values for harmonic currents of the PFC standards are complied with.
